(19) United States
(12) Patent Application Publication
(10) Pub. No.: US 2026/0028463 A1
(43) Pub. Date: Jan. 29, 2026

(54) RECYCLING METHOD AND RECYCLED PRODUCTS

(71) Applicant: BASF SE, Ludwigshafen am Rhein (DE)

(72) Inventors: Philipp Maximilian JUNG, Ludwigshafen am Rhein (DE); Paul NEUMANN, Ludwigshafen am Rhein (DE)

(21) Appl. No.: 19/143,415

(22) PCT Filed: Dec. 20, 2023
(86) PCT No.: PCT/EP2023/087025

§ 371 Date: Jun. 26, 2025

(30) Foreign Application Priority Data
Dec. 30, 2022 (EP) 22217315.5
Feb. 27, 2023 (EP) 23158796.5

(51) Int. Cl. C08J 11/06; C08J 3/09

(52) U.S. Cl. CPC C08J 11/06; C08J 3/095; C08J 3/096; C08J 2375/02; C08J 2477/00

(57) ABSTRACT

Herein a specific method for the treatment of a polymer blend is described. The obtained material can be converted to obtain specific materials and products.

The present invention relates to a process for separating a polymer PM1, e.g. polyamide, from a polymer blend PB1 comprising the polymer PM1 and a further polymer PM2, e.g. polyurethane or polyurea, using a specific solvent S1 to obtain a polymer blend PB2. In addition, the present invention relates to the polymer blend PB2 itself which differs from the conventional polymer blend PB1 due to the separation process. Further, the present invention refers to a polymer product PP1 comprising the polymer blend PB2.

Hand-in-hand with the vigorous growth of the polymer production industry, there has been a concomitant increase in the problem of removing and re-using polymer waste or reject goods. There is therefore considerable interest both on ecological and on economic grounds for industrially utilizing the ever-increasing quantities of polymer waste.

Polymer blends are difficult to recycle because not all of the waste components can be recycled through the same process. Examples of polymer blends are shoe scraps, mixed material fibers or composites. Classic polar organic solvents cannot be used on an industrial scale due to their price, toxicity, explosion hazard and high boiling point. Thus, there is a demand for an energy-efficient, non-toxic separation process that selectively separates the polymers present in a polymer blend.

In particular, mixed fibers containing polyamides and polyurethanes or polyureas (elastane) are a problem for the textile industry since already slight contamination with polyurethanes or polyureas (elastane) is leading to polyamide fibers not being recyclable.

Therefore, it is an object of the present invention to provide an improved method for treating and separating a polymer blend. In addition, the present invention provides an improved method to obtain a polymer (blend) or polymer product having improved reusability and workability. Thus, it is possible to close a recycling loop for a polymer, e.g. polyamide, polyurethane and/or polyurea.

This object is at least partially solved by a method, comprising the following steps:
providing a polymer blend PB1 and a solvent S1,
wherein the polymer blend PB1 comprises:
i) a polymer PM1, and
ii) a polymer PM2, and
wherein the solvent S1 comprises:
i) a solvent SO1, and
ii) preferably a solvent SO2, and
preferably wherein the solvent SO1 and the solvent SO2 are not the same, and wherein the solubility of the polymer PM1 in the solvent S1 (g/L) is lower than the solubility of the polymer PM2 in the solvent S1 (g/L); and
contacting the polymer blend PB1 with the solvent S1 to obtain a mixture MI1; and
preferably separating the mixture MI1 to obtain a polymer blend PB2 comprising the polymer PM1 and a solvent S2 comprising the polymer PM2.

The conditions in the contacting step are not particularly limited. Preferably, in the contacting step, one or more of the following conditions is/are fulfilled:
i) the polymer blend PB1 and the solvent S1 are at least once stirred and/or sonicated, preferably for a time t1;
ii) the polymer blend PB1 and the solvent S1 are in contact for a/the time t1;
iii) the polymer blend PB1 and the solvent S1 are at least once heated to a temperature T1, preferably for a/the time t1;
   wherein the time t1 is 0.1 seconds or more and 7 days or less, preferably 1 min or more and 48 hours or less, more preferably 1 hour or more and 32 hours or less, more preferably 10 hours or more and 20 hours or less; and
   wherein the temperature T1 is 0° C. or more and less than Tm, measured by DSC, of the polymer PM1, preferably 5° C. or more and 250° C. or less, more preferably 10° C. or more and 200° C. or less, more preferably 12° C. or more and 85° C. or less, more preferably 15° C. or more and 75° C. or less, more preferably 17° C. or more and 65° C. or less, more preferably 20° C. or more and 60° C. or less, more preferably 25° C. or more and 55° C. or less, more preferably 30° C. or more and 50° C. or less.

Especially, if the polymer blend PB1 and the solvent S1 are in contact for 1 min or more, preferably 1 hour or more, more preferably 10 hours or more, the separation is further improved. In addition, the inventors found that surprisingly if the polymer blend PB1 and the solvent S1 are at least once heated to 20° C. or more, preferably 25° C. or more, more preferably 30° C. or more, the dissolving of the polymer PM2 is further improved. In addition, especially if the solvent SO1 and the solvent SO2 are used, it is possible to decrease the heating temperature T1 to 85° C. or less, preferably 75° C. or less, more preferably 65° C. or less, more preferably 60° C. or less, more preferably 55° C. or less, more preferably 50° C. or less. Thus, the overall performance of the method is further improved. The order of contacting the polymer blend PB1 and the solvent SO1 and the solvent SO2 is not particularly limited. Preferably, the solvent SO1 and the solvent SO2 are mixed first and then brought into contact with the polymer blend PB1. Thus, an equilibrium in the mixture MI1 can be reached faster. However, according to another preferred embodiment of the invention, first the polymer blend PB1 and the solvent SO1 are brought into contact and then the solvent SO2 is added.

In a preferred embodiment the method further comprises the step:
separating the mixture MI1 to obtain a polymer blend PB2 comprising the polymer PM1 and a solvent S2 comprising the polymer PM2.

The way of separating is not particularly limited. Preferably, separating the mixture MI1 to obtain a polymer blend PB2 comprising the polymer PM1 and a solvent S2 comprising the polymer PM2 is a physical separation method, preferably filtering and/or decanting the mixture MI1 to obtain the polymer blend PB2 comprising the polymer PM1 and the solvent S2 comprising the polymer PM2. Especially, if the polymer blend PB2 and the solvent S2 are separated by filtration, the yield can be improved.

The ratio [weight/weight] of the polymer blend PB1 to the solvent S1 during the contacting step is not particularly limited. Preferably, the ratio [weight/weight] of the polymer blend PB1 to the solvent S1 during the contacting step is 0.001 or more and 1000 or less, preferably 0.005 or more and 50 or less, more preferably 0.01 or more and 25 or less, more preferably 0.02 or more and 15 or less, more preferably 0.03 or more and 10 or less, more preferably 0.04 or more and 5 or less, more preferably 0.05 or more and 4 or less, more preferably 0.06 or more and 3 or less, more preferably 0.07 or more and 2 or less, more preferably 0.08 or more and 1 or less, more preferably 0.09 or more and 0.5 or less, more preferably 0.10 or more and 0.15 or less, more preferably about 0.1.

Especially, if the ratio is 4 or less, preferably 3 or less, more preferably 2 or less, more preferably 1 or less, more preferably 0.5 or less, more preferably 0.15 or less, more preferably 0.1 or less, the dissolving is improved. Further, if the ratio is 0.001 or more, preferably 0.005 or more, more preferably 0.01 or more, more preferably 0.02 or more, more preferably 0.03 or more, more preferably 0.04 or more, more preferably 0.05 or more, more preferably 0.06 or more, more preferably 0.07 or more, more preferably 0.08 or more, more preferably 0.09 or more, more preferably 0.10 or more, more preferably 0.1 or more, the overall performance is further improved.

In a preferred embodiment, the method further comprises one or both of the following step(s):
washing the polymer blend PB2 with the solvent S1 to obtain a polymer blend PB2, which has been washed; and/or
drying the polymer blend PB2,
preferably by contact drying, convection drying, radiation drying, and/or
wherein the drying step is performed under one or more of the following conditions:
   a pressure of 0.01 mbar or more and 1013 mbar or less, preferably 0.05 mbar or more and 500 mbar or less, more preferably 0.1 mbar or more and 200 mbar or less;
   a temperature of 0° C. or more and less than Tm, measured by DSC, of the polymer PM1, preferably 15° C. or more and 250° C. or less, more preferably 20° C. or more and 180° C. or less, more preferably 40° C. or more and 130° C. or less, more preferably 50° C. or more and 100° C. or less, and
   in an atmosphere having at least 90 volume-%, preferably at least 95 volume-%, more preferably at least 98 volume-%, more preferably about 100 volume-%, nitrogen.

Thus, the purity and quality of the polymer blend PB2 can be further improved.

In a preferred embodiment, the method is a method for the treatment of a polymer blend PB1, and/or for recycling of a polymer blend PB1, and/or for producing a monomer, preferably monomer MO1 and/or monomer MO2 and/or monomer MO3, and/or a polymer, preferably a polymer PM3 and/or a polymer PM4, and/or a polymer product, preferably a polymer product PP1 and/or a polymer product PP2 and/or a polymer product PP3 and/or a polymer product PP4, and/or a polyol composition, preferably a polyol composition PC1.

The obtained polymer blend PB2 and/or solvent S2 can be further processed by several methods. Several methods for the conversion are well known to a person skilled in the art, e.g. T. A. Osswald, E. Baur, N. Rudolph, Plastics Handbook, 5th Revised edition (2019), ISBN: 9781569905593; Biobasierte und bioabbaubare Kunststoffe, 2. edition (2019), ISBN: 9783410296348; N. Niessner, Recycling of Plastics, 1. Edition (2022), ISBN 978-1569908563, WO2022067251 A1; and WO2020163256 A2. The person skilled in the art also understands that, depending on the recycling method, the polymer product, e.g. polymer product PP1, must contain specific components, e.g. if the polymer blend PB1, comprising polymer PM1, is formed to the polymer product PP1, then the polymer product PP1 must also contain polymer PM1. In contrast, if the polymer blend PB1 is converted to the polymer product PP1 via pyrolysis, then the product PP1 must not comprise the polymer PM1, but can comprise polymer PM1.

Thus, preferably the method further comprises the following step:
converting the solvent S2 to obtain a monomer, preferably monomer MO1 and/or monomer MO2; and/or a polymer, preferably a polymer PM3 and/or a polymer PM4; and/or a polymer product, preferably a polymer product PP1 and/or a polymer product PP2 and/or a polymer product PP3 and/or a polymer product PP4; and/or a polyol composition, preferably a polyol composition PC1.

In a preferred embodiment, the converting step comprises the following step:
adding of water to the solvent S2 until the polymer PM2 precipitates to obtain the polymer PM4.

A person skilled in the art understands that the polymer PM2 and the polymer PM4 (precipitated and/or recycled polymer PM2) are the same.

In a further preferred embodiment, the converting step comprises the following step:
removing of the solvent; preferably the solvent SO1, more preferably the solvent SO1 and the solvent SO2; from the solvent S2 to obtain the polymer PM4.

In a further preferred embodiment, preferably wherein the polymer PM2 and/or the polymer PM4 is/are a polyurethane, the converting step comprises the following step:
depolymerizing the polymer PM4, preferably wherein the depolymerization is carried out by a method selected from hydrolysis, glycolysis, hydrogenation or by aminolysis, to obtain a mixture MI2 comprising monomer MO2, preferably and a polyol composition PC1.

In a further preferred embodiment, preferably wherein the polymer PM2 and/or the polymer PM4 is/are a polyurethane, the converting step comprises the following step:
sorting and/or purifying and/or separating the mixture MI2, obtained in the depolymerization of the polymer PM4, to obtain the monomer MO2 and/or the polyol composition PC1.

In a further preferred embodiment, the converting step comprises the following step(s):
polymerizing the monomer MO2, preferably wherein monomer MO2 is comprises an isocyanate group or an amine derivative thereof, and a molecule containing an OH-group to obtain the polymer PM3, preferably wherein the polymer PM3 is a polyurethane; and/or
polymerizing the polyol composition PC1 and a monomer containing a group reactive with an OH-group, preferably a monomer containing an isocyanate group; optionally together with (a) further monomer(s) MO4, and/or optionally together with (an) additive(s) A1; to obtain the polymer PM3, preferably wherein the polymer PM3 is a polyurethane.

It is not only possible to further process the solvent S2, but also to further process the polymer blend PB2 obtained according to the method described herein. Thus, preferably, the method comprises the following step:
converting the polymer blend PB2 to obtain a monomer, preferably monomer MO1 and/or monomer MO3; and/or a polymer, preferably a polymer PM3; and/or a polymer product, preferably a polymer product PP1 and/or a polymer product PP2 and/or a polymer product PP3 and/or a polymer product PP4.

In a preferred embodiment, the converting step comprises the following step(s):
biodegrading the polymer blend PB2 and/or the solvent S2 and/or the polymer PM4 to obtain a biomass BM1;
optionally converting the biomass BM1 in a monomer precursor MP1; and
converting the biomass BM1 and/or the monomer precursor MP1 to obtain a monomer MO1.

In another preferred embodiment, the converting step comprises the following steps:
pyrolyzing the polymer blend PB2 and/or the solvent S2 and/or the polymer PM4 to obtain a pyrolysis oil and/or pyrolysis gas PY1;
steam cracking the pyrolysis oil and/or pyrolysis gas PY1 to obtain a monomer precursor MP1; and
converting the monomer precursor MP1 to obtain a monomer MO1. Thus, a very pure monomer MO1 can be obtained.

In another preferred embodiment, the converting step comprises the following steps:
depolymerizing the polymer blend PB2 to obtain a mixture MI3 comprising at least one monomer MO3; and
preferably sorting and/or purifying and/or separating the mixture MI3 to obtain a monomer MO3.

Thus, a very pure monomer MO2 can be obtained.

In another preferred embodiment, the converting step comprises the following steps:
polymerizing the mixture MI2 and/or mixture MI3 and/or monomer MO1 and/or monomer MO2 and/or monomer MO3; optionally together with (a) further monomer(s) MO4, and/or optionally together with (an) additive(s) A1; to obtain the polymer PM3.

In another preferred embodiment, the converting step comprises the following step:
forming the polymer PM3 and/or the polymer PM4 and/or the polymer blend PB2, preferably together with (a) further polymer(s) and/or additive(s), to obtain a polymer product, preferably the polymer product PP1 and/or the polymer product PP2 and/or the polymer product PP3 and/or the polymer product PP4.

Thus, for example, it is possible to directly form the polymer blend PB2 obtained according to the method described herein to obtain the polymer product PP1, i.e. mechanical recycling of the polymer blend PB2.

With the method described herein, it is possible to close an entire recycling loop for a polymer blend. As a consequence, the method described herein can be repeated one or more times. Thus, preferably the method further comprises the following step:
repeating the previous steps one or more times.

In addition, it is possible that the polymer blend PB1 is treated according to the method described herein and is then further recycled by a further (different) method. Thus, preferably the method further comprises one or more of the following step(s):
repeating the method described herein one or more times, to obtain a polymer product PP2, preferably wherein the content of the polymer product PP1 in the polymer product PP2 is a content CO1,
recycle the polymer product PP1 one or more times to obtain a polymer product PP3, preferably wherein the content of the polymer product PP1 in the polymer product PP3 is a/the content CO1,
recycle the polymer product PP1 one or more times to obtain a recycled material RM1 and converting or forming the recycled material RM1 to obtain a polymer product PP4 comprising the recycled material RM1, preferably wherein the content of the polymer product PP1 and/or the recycled material RM1 in the polymer product PP4 is a/the content CO1; and
   wherein the content CO1 is 1 weight-% or more, preferably 2 weight-% or more, more preferably 5 weight-% or more, more preferably 15 weight-% or more, more preferably 30 weight-% or more, more preferably 40 weight-% or more, more preferably 60 weight-% or more, more preferably 80 weight-% or more, more preferably 90 weight-% or more, more preferably 95 weight-% or more; and/or, preferably and,
   preferably wherein the content CO1 is 100 weight-% or less, preferably 95 weight-% or less, more preferably 90 weight-% or less, more preferably 50 weight-% or less, more preferably 25 weight-% or less, more preferably 10 weight-% or less; and
   preferably wherein the polymer product PP1 and the polymer product PP2, PP3, and/or PP4 are the same.

Especially, if the content CO1 is 30 weight-% or more, preferably 40 weight-% or more, more preferably 60 weight-% or more, more preferably 80 weight-% or more, more preferably 90 weight-% or more, more preferably 95 weight-% or more, a polymer product can be obtained, having improved properties, especially improved recycling properties.

In a further preferred embodiment, the method further comprises the following step:
certifying the polymer PM1, PM2, PM3 and/or PM4 and/or the polymer blend PB2 and/or the polymer product PP1, PP2, PP3 and/or PP4 as circular in accordance with a standard or protocol, preferably based on identity preservation and/or segregation and/or mass balance and/or book and claim chain of custody models, preferably based on mass balance, preferably the International Sustainability and Carbon Certification (ISCC) standard.

According to a further aspect, the present invention is also directed to a polymer PM4, obtained by or obtainable by the method described herein.

According to the present invention, it is also possible to use the polymer PM4 described herein and/or obtained by or obtainable by the method described herein for the production of a polymer, preferably polymer product PP1, and/or in a recycling process.

According to a further aspect, the present invention is also directed to a polyol composition PC1, obtained by or obtainable by the method described herein.

According to the present invention, it is also possible to use the polyol composition PC1 described herein and/or obtained by or obtainable by the method described herein for the production of a polymer, preferably polymer product PP1, and/or in a recycling process.

According to a further aspect, the present invention is also directed to a polymer blend PB2, obtained by or obtainable by the method described herein, preferably comprising the polymer PM1.

According to the present invention, it is also possible to use the polymer blend PB2 described herein and/or obtained by or obtainable by the method described herein for the production of a polymer, preferably polymer product PP1, and/or in a recycling process.

According to a further aspect, the present invention is also directed to a polymer PM3 obtained by or obtainable by the method described herein.

According to the present invention, it is also possible to use the polymer PM3 described herein and/or obtained by or obtainable by the method described herein for the production of a polymer, preferably polymer product PP1, and/or in a recycling process.

According to a further aspect, the present invention is also directed to a polymer product PP1, PP2, PP3 and/or PP4, obtained by or obtainable by the method described herein; and/or wherein the polymer product PP1, PP2, PP3 and/or PP4 comprises, preferably consists of, the polymer blend PB2 and/or the polymer PM1, PM2, PM3 and/or PM4, preferably obtained by or obtainable by the method described herein; preferably and one or more additive(s) A1.

According to the present invention, it is also possible to use the polymer product PP1, PP2, PP3 and/or PP4, preferably as described herein, in a recycling process, preferably a mechanical recycling process. The inventors recognized that surprisingly the recycling of the polymer products PP1 to PP4, especially mechanical recycling, is easier, especially if the polymer product PP1 to PP4 comprises the polymer blend PP2, compared to an untreated polymer product. Without wishing to be bound to theory, the reason therefore is that the polymer product is depleted of short polymer fragments. The same applies to the polymers PM3 and PM4, the polyol compositions PC1 and the polymer blend PB2 described herein.

The polymer blend PB2 and/or the polymer product PP1 comprises the polymer PM1, preferably a polyamide. The inventors found that surprisingly the IR-spectrum/a of the polymer blend PB2 and/or the polymer products PP1 to PP4, may differ from an IR spectrum of a newly manufactured polymer, preferably polyamide, and/or newly manufactured polymer blends and/or polymer products, preferably comprising polyamide.

Thus, in a preferred embodiment, preferably wherein the polymer blend PB2 and/or the polymer product PP1, PP2, PP3 and/or PP4 comprise(s) a/the polymer PM1, more preferably a polyamide, the polymer blend PB2 and/or the polymer product PP1, PP2, PP3 and/or PP4 exhibit(s) a peak, preferably a peak indicating a v(C═O)-vibration, at 1600 cm⁻¹ or more and 1800 cm⁻¹ or less, preferably 1630 cm⁻¹ or more and 1680 cm⁻¹ or less, in an IR-spectrum; and/or the polymer blend PB2 and/or the polymer product PP1, PP2, PP3 and/or PP4 exhibit(s) a peak, preferably a peak indicating a v(C—H) and/or δ(C—N—H) vibration, at 1450 cm⁻¹ or more and 1600 cm⁻¹ or less, preferably 1530 cm⁻¹ or more and 1570 cm⁻¹ or less, in an IR-spectrum; and/or the polymer blend PB2 and/or the polymer product PP1, PP2, PP3 and/or PP4 exhibit(s) a peak, preferably a peak indicating a v(C—H) vibration, at 2500 cm⁻¹ or more and 3500 cm⁻¹ or less, preferably 2700 cm⁻¹ to 3200 cm⁻¹, in an IR-spectrum. Especially, a peak, preferably a peak indicating a v(C—H) and/or δ(C—N—H) vibration, at 1450 cm⁻¹ or more and 1600 cm⁻¹ or less, preferably 1530 cm⁻¹ to 1570 cm⁻¹, in an IR-spectrum, indicates that the polymer blend PB2 and the polymer product PP1 are obtainable by the method described herein.

The mass average molar mass Mw of the polymer blend PB2 and/or the polymer product PP1 is not particularly limited. Preferably, the mass average molar mass Mw of the polymer blend PB2 and/or the polymer product PP1 is/are 1.00*10⁴ or more, preferably 5.00*10⁴ or more, more preferably 5.40*10⁴ or more, more preferably 5.80*10⁴ or more, more preferably 6.30*10⁴ or more, more preferably 6.80*10⁴ or more, more preferably 7.10*10⁴ or more, more preferably 7.30*10⁴ or more; and/or 1.00*10⁵ or less, preferably 8.00*10⁴ or less, more preferably 7.50*10⁴ or less, more preferably 7.40*10⁴ or less, more preferably 7.00*10⁴ or less, more preferably 6.70*10⁴ or less, more preferably 6.50*10⁴ or less, more preferably 6.30*10⁴ or less, more preferably 6.10*10⁴ or less, more preferably 5.85*10⁴ or less, more preferably 5.70*10⁴ or less, more preferably 5.50*10⁴ or less, more preferably 5.30*10⁴ or less, more preferably 5.10*10⁴ or less. Especially, if the mass average molar mass Mw is high, i.e. 1.00*10⁴ or more, preferably 5.00*10⁴ or more, more preferably 5.40*10⁴ or more, more preferably 5.80*10⁴ or more, more preferably 6.30*10⁴ or more, more preferably 6.80*10⁴ or more, more preferably 7.10*10⁴ or more, more preferably 7.30*10⁴ or more, the skin sensitivity of the polymer blend PB2 and/or the polymer product PP1 is improved. Without wishing to be bound to theory, a high value in the mass average molar mass Mw indicates a low content of very short polymers and/or oligomers. These short polymers and/or oligomers might diffuse out of the polymer blend PB1 and/or polymer blend PB2 and/or the polymer product PP1 and cause skin irritations. The inventors surprisingly found that especially if caprolactam; preferably caprolactam and the solvent SO2, preferably alcohol (methanol) and/or water, more preferably water; is present in the solvent S1, high values can be obtained. Further, if the mass average molar mass Mw is low, the processing of the polymer blend PB2 and/or the polymer product PP1 is improved. Thus, preferably the mass average molar mass Mw of the polymer blend PB2 and/or the polymer product PP1 is 1.00*10⁵ or less, preferably 8.00*10⁴ or less, more preferably 7.50*10⁴ or less, more preferably 7.40*10⁴ or less, more preferably 7.00*10⁴ or less, more preferably 6.70*10⁴ or less, more preferably 6.50*10⁴ or less, more preferably 6.30*10⁴ or less, more preferably 6.10*10⁴ or less, more preferably 5.85*10⁴ or less, more preferably 5.70*10⁴ or less, more preferably 5.50*10⁴ or less, more preferably 5.30*10⁴ or less, more preferably 5.10*10⁴ or less.

The number average molar mass Mn of the polymer blend PB2 and/or the polymer product PP1 is not particularly limited. Preferably, the number average molar mass Mn of the polymer blend PB2 and/or the polymer product PP1 is/are 2.00*10⁴ or more, preferably 2.10*10⁴ or more, more preferably 2.20*10⁴ or more, more preferably 2.30*10⁴ or more, more preferably 2.40*10⁴ or more, more preferably 2.48*10⁴ or more, more preferably 2.50*10⁴ or more, more preferably 2.60*10⁴ or more, more preferably 2.65*10⁴ or more, more preferably 2.70*10⁴ or more; and/or 4.00*10⁴ or less, preferably 3.00*10⁴ or less, more preferably 2.70*10⁴ or less, more preferably 2.65*10⁴ or less, more preferably 2.60*10⁴ or less, more preferably 2.55*10⁴ or less, more preferably 2.50*10⁴ or less, more preferably 2.46*10⁴ or less. Especially, if the number average molar mass Mn is high, i.e. 2.00*10⁴ or more, preferably 2.10*10⁴ or more, more preferably 2.20*10⁴ or more, more preferably 2.30*10⁴ or more, more preferably 2.40*10⁴ or more, more preferably 2.48*10⁴ or more, more preferably 2.50*10⁴ or more, more preferably 2.60*10⁴ or more, more preferably 2.65*10⁴ or more, more preferably 2.70*10⁴ or more, the skin sensitivity of the polymer blend PB2 and/or the polymer product PP1 can be improved. Without wishing to be bound to theory, a high value in the number average molar mass Mn indicates a low content of very short polymers and/or oligomers. These short polymers and/or oligomers might diffuse out of the polymer blend PB1 and/or the polymer blend PB2 and/or the polymer product PP1 and case skin irritations. The inventors found that surprisingly, especially if caprolactam; preferably caprolactam and the solvent SO2, preferably alcohol (methanol) and/or water, more preferably water; is present in the solvent S1, high values can be obtained. Further, if the number average molar mass Mn is low, the processing of the polymer blend PB2 and/or the polymer product PP1 is improved. Thus, preferably the number average molar mass Mn of the polymer blend PB2 and/or the polymer product PP1 is 4.00*10⁴ or less, preferably 3.00*10⁴ or less, more preferably 2.70*10⁴ or less, more preferably 2.65*10⁴ or less, more preferably 2.60*10⁴ or less, more preferably 2.55*10⁴ or less, more preferably 2.50*10⁴ or less, more preferably 2.46*10⁴ or less.

In a preferred embodiment, preferably wherein the polymer PM1 is a polyamide and/or preferably wherein the polymer blend PB1 and/or the polymer blend PB2 comprise(s) an additive, preferably a colorant; the content of amino end groups in the polymer blend PB2 and/or the polymer product PP1 is/are 1 mmol/kg or more, preferably 2 mmol/kg or more, more preferably 3 mmol/kg or more, more preferably 4 mmol/kg or more, more preferably 5 mmol/kg or more, more preferably 6 mmol/kg or more, more preferably 7.0 mmol/kg or more, more preferably 7.2 mmol/kg or more, more preferably 7.4 mmol/kg or more, more preferably 7.6 mmol/kg or more, more preferably 7.8 mmol/kg or more, more preferably 8.0 mmol/kg or more, more preferably 8.2 mmol/kg or more, more preferably 9.0 mmol/kg or more, more preferably 15 mmol/kg or more; and/or 100 mmol/kg or less, preferably 75 mmol/kg or less, more preferably 50 mmol/kg or less, more preferably 40 mmol/kg or less, more preferably 30 mmol/kg or less, more preferably 20 mmol/kg or less, more preferably 10 mmol/kg or less, more preferably 9.0 mmol/kg or less, more preferably 8.5 mmol/kg or less, more preferably 8.2 mmol/kg or less, more preferably 8.0 mmol/kg or less, more preferably 7.5 mmol/kg or less, more preferably 7.4 mmol/kg or less, more preferably 7.3 mmol/kg or less, more preferably 7.2 mmol/kg or less. Especially, if the content of amino end groups is low, the separation is improved. Without wishing to be bound to theory, a low content of amino end groups, i.e. 100 mmol/kg or less, preferably 75 mmol/kg or less, more preferably 50 mmol/kg or less, more preferably 40 mmol/kg or less, more preferably 30 mmol/kg or less, more preferably 20 mmol/kg or less, more preferably 10 mmol/kg or less, more preferably 9.0 mmol/kg or less, more preferably 8.5 mmol/kg or less, more preferably 8.2 mmol/kg or less, more preferably 8.0 mmol/kg or less, more preferably 7.5 mmol/kg or less, more preferably 7.4 mmol/kg or less, more preferably 7.3 mmol/kg or less, more preferably 7.2 mmol/kg or less, indicates that the colorant is still intact and still connected, e.g. bound, to the amino end groups of the polymer and less colorant is present in the solvent S2. Further, if the content of amino end groups is high, i.e. 1 mmol/kg or more, preferably 2 mmol/kg or more, more preferably 3 mmol/kg or more, more preferably 4 mmol/kg or more, more preferably 5 mmol/kg or more, more preferably 6 mmol/kg or more, more preferably 7.0 mmol/kg or more, more preferably 7.2 mmol/kg or more, more preferably 7.4 mmol/kg or more, more preferably 7.6 mmol/kg or more, more preferably 7.8 mmol/kg or more, more preferably 8.0 mmol/kg or more, more preferably 8.2 mmol/kg or more, more preferably 9.0 mmol/kg or more, more preferably 15 mmol/kg or more, the workability of the polymer blend PB2 is improved, especially if the polymer blend is further converted to the polymer product PP1, especially, if the polymer product PP1 is a fiber or textile.

In a preferred embodiment, preferably wherein the polymer PM1 is a polyamide and/or preferably wherein the polymer blend PB1 and/or the polymer blend PB2 comprise(s) an additive, preferably a colorant; the content of carboxyl end groups in the polymer blend PB2 and/or the polymer product PP1 is/are 1 mmol/kg or more, preferably 25 mmol/kg or more, more preferably 50 mmol/kg or more, more preferably 60 mmol/kg or more, more preferably 65 mmol/kg or more, more preferably 66 mmol/kg or more, more preferably 70 mmol/kg or more, more preferably 73.0 mmol/kg or more, more preferably 73.2 mmol/kg or more, more preferably 73.3 mmol/kg or more, more preferably 73.4 mmol/kg or more, more preferably 73.6 mmol/kg or more, more preferably 73.8 mmol/kg or more, more preferably 74.0 mmol/kg or more; and/or 100 mmol/kg or less, preferably 90 mmol/kg or less, more preferably 80 mmol/kg or less, more preferably 75 mmol/kg or less, more preferably 74.9 mmol/kg or less, more preferably 74.8 mmol/kg or less, more preferably 74.7 mmol/kg or less, more preferably 74.6 mmol/kg or less, more preferably 74.5 mmol/kg or less, more preferably 74.4 mmol/kg or less, more preferably 74.3 mmol/kg or less, more preferably 74.2 mmol/kg or less, more preferably 74.1 mmol/kg or less, more preferably 74.0 mmol/kg or less, more preferably 70 mmol/kg or less, more preferably 50 mmol/kg or less, more preferably 25 mmol/kg or less. Especially, if the content of carboxyl end groups in the polymer blend PB2 and/or the polymer product PP1 is/are 1 mmol/kg or more, preferably 25 mmol/kg or more, more preferably 50 mmol/kg or more, more preferably 60 mmol/kg or more, more preferably 65 mmol/kg or more, more preferably 66 mmol/kg or more, more preferably 70 mmol/kg or more, more preferably 73.0 mmol/kg or more, more preferably 73.2 mmol/kg or more, more preferably 73.3 mmol/kg or more, more preferably 73.4 mmol/kg or more, more preferably 73.6 mmol/kg or more, more preferably 73.8 mmol/kg or more, more preferably 74.0 mmol/kg or more, the possibility of post modification, e.g. dyeability, of the polymer is/are improved.

In a preferred embodiment, preferably wherein the polymer PM1 is a polyamide and/or preferably wherein the polymer blend PB1 and/or the polymer blend PB2 comprise(s) an additive, preferably a colorant; the ratio of the content of carboxyl end groups [mmol/kg] to the content of amino end groups [mmol/kg] of the polymer blend PB2 and/or the polymer product PP1 is/are 0.1 or more, preferably 1 or more, more preferably 2 or more, more preferably 3 or more, more preferably 4 or more, more preferably 5 or more, more preferably 6 or more, more preferably 7 or more, more preferably 8.0 or more, more preferably 8.2 or more, more preferably 8.5 or more, more preferably 9.0 or more, more preferably 9.8 or more, more preferably 10.0 or more; and/or 100 or less, preferably 50 or less, more preferably 25 or less, more preferably 20 or less, more preferably 15 or less, more preferably 11 or less, more preferably 10.0 or less, more preferably 9.8 or less, more preferably 9.5 or less, more preferably 9.3 or less, more preferably 8.1 or less. Especially, if the ratio is low, i.e. 100 or less, preferably 50 or less, more preferably 25 or less, more preferably 20 or less, more preferably 15 or less, more preferably 11 or less, more preferably 10.0 or less, more preferably 9.8 or less, more preferably 9.5 or less, more preferably 9.3 or less, more preferably 8.1 or less, the workability is improved. A low value can be particularly obtained, if the solvent SO1 is caprolactam, preferably and the solvent SO2 is water and/or methanol, preferably water. In addition, if the ratio is high, i.e. 0.1 or more, preferably 1 or more, more preferably 2 or more, more preferably 3 or more, more preferably 4 or more, more preferably 5 or more, more preferably 6 or more, more preferably 7 or more, more preferably 8.0 or more, more preferably 8.2 or more, more preferably 8.5 or more, more preferably 9.0 or more, more preferably 9.8 or more, more preferably 10.0 or more, the colorant is still intact and still connected, e.g. bound to the amino groups of the polymer, and less colorant is present in the solvent S2. A high value can be especially obtained if the solvent S1 comprises, preferably consists of, caprolactam as the solvent SO1 and water and/or methanol as the solvent SO2.

The content of extractables of the polymer blend PB2 and/or the polymer product PP1 is not particularly limited. In a preferred embodiment, the content of extractables of the polymer blend PB1 and/or the polymer blend PB2 and/or the polymer product PP1 is/are 0 weight-% or more, preferably 0.1 weight-% or more, more preferably 0.1 weight-% or more, more preferably 0.2 weight-% or more, more preferably 0.3 weight-% or more, more preferably 0.5 weight-% or more, more preferably 0.8 weight-% or more, more preferably 1.0 weight-% or more, more preferably 1.2 weight-% or more, more preferably 1.4 weight-% or more, more preferably 1.6 weight-% or more, more preferably 1.8 weight-% or more, more preferably 2.0 weight-% or more, more preferably 2.2 weight-% or more, more preferably 2.5 weight-% or more, more preferably 2.8 weight-% or more, more preferably 3.0 weight-% or more; and/or the content of extractables of the polymer blend PB1 and/or the polymer blend PB2 and/or the polymer product PP1 is/are 5 weight-% or less, preferably 4 weight-% or less, more preferably 3.5 weight-% or less, more preferably 3.2 weight-% or less, more preferably 3.0 weight-% or less, more preferably 2.5 weight-% or less, more preferably 2.0 weight-% or less, more preferably 1.8 weight-% or less, more preferably 1.3 weight-% or less, more preferably 1.0 weight-% or less, more preferably 0.8 weight-% or less, more preferably 0.6 weight-% or less. If the value is low, i.e. 5 weight-% or less, preferably 4 weight-% or less, more preferably 3.5 weight-% or less, more preferably 3.2 weight-% or less, more preferably 3.0 weight-% or less, more preferably 2.5 weight-% or less, more preferably 2.0 weight-% or less, more preferably 1.8 weight-% or less, more preferably 1.3 weight-% or less, more preferably 1.0 weight-% or less, more preferably 0.8 weight-% or less, more preferably 0.6 weight-% or less, the purity of the polymer blend is improved. However, to obtain a very low value, a very high amount of the solvent blend SO1 must be used in the method described herein. Thus, if the content of the extractables is very low, the costs for the solvents may exceed the efficacy. Thus, preferably the content of extractables of the polymer blend PB2 is 0.1 weight-% or more, preferably 0.1 weight-% or more, more preferably 0.2 weight-% or more, more preferably 0.3 weight-% or more, more preferably 0.5 weight-% or more, more preferably 0.8 weight-% or more, more preferably 1.0 weight-% or more, more preferably 1.2 weight-% or more, more preferably 1.4 weight-% or more, more preferably 1.6 weight-% or more, more preferably 1.8 weight-% or more, more preferably 2.0 weight-% or more, more preferably 2.2 weight-% or more, more preferably 2.5 weight-% or more, more preferably 2.8 weight-% or more, more preferably 3.0 weight-% or more.

The relative viscosity of the polymer blend PB2 and/or the polymer product PP1 is not particularly limited. Preferably, the relative viscosity of the polymer blend PB1 and/or the polymer blend PB2 and/or the polymer product PP1 is/are 2.00 or more, preferably 2.10 or more, more preferably 2.20 or more, more preferably 2.20 or more, more preferably 2.21 or more, more preferably 2.22 or more, more preferably 2.274 or more, more preferably 2.275 or more, more preferably 2.276 or more, more preferably 2.30 or more, more preferably 2.40 or more; and/or the relative viscosity the polymer blend PB1 and/or the polymer blend PB2 and/or the polymer product PP1 is/are 4.00 or less, preferably 3.50 or less, more preferably 3.00 or less, more preferably 2.50 or less, more preferably 2.45 or less, more preferably 2.40 or less, more preferably 2.30 or less, more preferably 2.28 or less, more preferably 2.27 or less. Especially, if the relative viscosity is low, i.e. 4.00 or less, preferably 3.50 or less, more preferably 3.00 or less, more preferably 2.50 or less, more preferably 2.45 or less, more preferably 2.40 or less, more preferably 2.30 or less, more preferably 2.28 or less, more preferably 2.27 or less, the workability is improved.

The shape of the polymer blend PB1 is not particularly limited. Preferably, the polymer blend PB1 is a textile, a yarn, a monofilament, a foam, and/or an injection-moulded article, an extruded film; and mixtures thereof, preferably a textile. The separation can be improved, if the shape is filigree so that the contact area of the solvent S1 is increased. Thus, especially a textile, a yarn, a monofilament, a foam and an extruded film, preferably a textile, is preferred. To increase the contact area, the polymer blend PB1 can be crushed and/or shredded before it is brought into contact with the solvent S1 to obtain the mixture MI1.

The melting point of the polymer blend PB1 is not particular limited. Preferably, the polymer blend PB1 and/or the polymer blend PB2 and/or the polymer product PP1 is/are solid at 25° C., preferably 50° C., more preferably 75° C. Thus, the separation of the mixture MI1 can be improved.

The polymer blend PB1 may comprise several, e.g. 3 or more or 4 or more, polymers and several additives. Preferably, the polymer blend PB1 and/or the polymer blend PB2 and/or the polymer product PP1 comprise(s), preferably consist(s) of, the polymer PM1 and the polymer PM2 and one or more additive(s) A1. Thus, the complexity of the separation can be decreased and the purity of the separated polymers PM1 and PM2 can be improved.

The content of the polymer PM1 in the solvent S2, the polymer blend PB1, the polymer blend PB2, and/or the polymer product PP1 is not particularly limited. Preferably, the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 91 weight-% or more, more preferably 95 weight-% or more, more preferably 96 weight-% or more, polymer PM1 with regard to the solvent S2, the polymer blend PB1, the polymer blend PB2, and the polymer product PP1, respectively; and/or the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, polymer PM1 with regard to the solvent S2, the polymer blend PB1, the polymer blend PB2, and the polymer product PP1, respectively. Especially, if the content of the polymer PM1 in the polymer blend PB2, and/or the polymer product PP1 is high, e.g. 40 weight-% or more, preferably 50 weight-% or more, more preferably 60 weight-% or more, more preferably 70 weight-% or more, more preferably 80 weight-% or more, more preferably 90 weight-% or more, more preferably 91 weight-% or more, more preferably 95 weight-% or more, more preferably 96 weight-% or more, the workability is improved.

The content of the polymer PM2 in the solvent S2, the polymer blend PB1, the polymer blend PB2, and/or the polymer product PP1 is not particularly limited. Preferably, the solvent S2, the polymer blend PB1, the polymer blend PB2 and/or the polymer product PP1 comprise(s) 0.01 weight-% or more, preferably 0.1 weight-% or more, more preferably 1 weight-% or more, more preferably 3 weight-% or more, more preferably 5 weight-% or more, more preferably 10 weight-% or more, more preferably 25 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 95 weight-% or more, polymer PM2 with regard to the solvent S2, the polymer blend PB1, the polymer blend PB2, and the polymer product PP1, respectively; and/or the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, more preferably 3 weight-% or less, more preferably 2 weight-% or less, more preferably 1 weight-% or less, more preferably 0.5 weight-% or less, more preferably 0.1 weight-% or less, polymer PM2 with regard to the solvent S2, the polymer blend PB1, the polymer blend PB2, and the polymer product PP1, respectively. If the content of the polymer PM2 in the polymer blend PB2 and/or the polymer product PP1 is low, i.e. 20 weight-% or less, preferably 10 weight-% or less, more preferably 5 weight-% or less, more preferably 3 weight-% or less, more preferably 2 weight-% or less, more preferably 1 weight-% or less, more preferably 0.5 weight-% or less, more preferably 0.1 weight-% or less, the processability is improved. However, to achieve very high purity of the polymer blend PB2 and/or the polymer product PP1, a very large amount of the solvent S2 might be necessary and thus, costs and effort might exceed the benefit. Thus, preferably content of the polymer PM2 in the polymer blend PB2 and/or the polymer product PP1 is 0.01 weight-% or more, preferably 0.1 weight-% or more, more preferably 1 weight-% or more, more preferably 3 weight-% or more, more preferably 5 weight-% or more, more preferably 10 weight-% or more, more preferably 25 weight-% or more.

The content of the polymer PM1 and the polymer PM2 in the solvent S2, the polymer blend PB1, the polymer blend PB2, and/or the polymer product PP1 is not particularly limited. Preferably, the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 95 weight-% or more, polymer PM1 and polymer PM2 with regard to the solvent S2, the polymer blend PB1, the polymer blend PB2, and the polymer product PP1, respectively; and/or the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, polymer PM1 and polymer PM2 with regard to the solvent S2, the polymer blend PB1, the polymer blend PB2, and the polymer product PP1, respectively.

The content of the polymer PM1 and/or the polymer PM2 in the polymer blend PB1 can be controlled either by selecting a specific polymer blend or by determination of the respective polymer(s) in several polymer blends and then sorting these polymer blends to obtain the polymer blend PB1 having a specific content of the polymer PM1 and/or the polymer PM2.

The polymer PM1 is not particularly limited. Preferably, the polymer PM1 and/or the polymer PM3 is/are obtainable by polymerizing the solvent SO1, optionally together with the monomer(s) MO1, MO2, MO3 and/or MO4. Thus, the acceptance of traces of the solvent SO1 in the polymer blend PB2 and/or the polymer product PP1 is increased.

In a further preferred embodiment, the polymer PM1 and/or the polymer PM3 is/are a polyamide, preferably selected from PA 4, PA 5, PA 6, PA 7, PA 8, PA 9, PA 10, PA 11, PA 12, PA 45, PA 4.6, PA 5.5, PA 5.6, PA 6.6, PA 6/6.6, PA 6.9, PA 5.10, PA 6.10, PA 6.12, PA 6/6.36, PA 6.6/6.36, PA 9.6, PA 9.9, PA 9.10, PA 9.12, PA 12.12, PA 6.T, PA 8.T, PA 9.T, PA 10.T, PA 12.T, PA 6.I, PA 8.I, PA 9.I, PA 10.I, PA 12.I, PA 6.T/6, PA 6.T/10, PA 6.T/12, PA 6.T/6.I, PA 6.T/8.T, PA 6.T/9.T, PA 6.T/10.T, PA 6.T/12.T, PA 12.T/6.T, PA 6.T/6.I/6, PA 6.T/6.I/12, PA 6.T/6.I/6.10, PA 6.T/6.I/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.I, PA 8.T/8.6, PA 8.T/6.I, PA 10.T/6.T, PA 10.T/6.6, PA 10.T/10.I, PA 10.T/10.I/6.T, PA 10.T/6.I, PA 4.T/4.I/4.6, PA 4.T/4.I/6.6, PA 5.T/5.I, PA 5.T/5.1/5.6, PA 5.T/5.I/6.6, PA 6.T/6.I/6.6, PA MXDA.6, PA IPDA.I, PA IPDA.T, PA MACM.I, PA MACM.T, PA PACM.I, PA PACM.T, PA MXDA.I, PA MXDA.T, PA 6.T/IPDA.T, PA 6.T/MACM.T, PA 6.T/PACM.T, PA 6.T/MXDA.T, PA 6.T/6.I/8.T/8.I, PA 6.T/6.I/10.T/10.I, PA 6.T/6.I/IPDA.T/IPDA.I, PA 6.T/6.I/MXDA.T/MXDA.I, PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T; and copolymers and mixtures thereof; preferably PA 6 and PA 6.6; and copolymers and mixtures thereof, more preferably wherein the polymer PM1 and/or the polymer PM3 is/are PA 6 and/or PA 6.6, more preferably wherein the polymer PM1 and/or the polymer PM3 is/are PA 6. Especially, it is preferred that the polymer PM1 is PA 6 and the solvent SO1 is caprolactam. Thus, the purity of the polymer blend PB2 and/or the polymer product PP1 can be increased.

In a further preferred embodiment, the polymer PM1 is not polyurea, preferably is not polyurethane and polyurea. Especially, it is preferred that the polymer PM1 is a polyamide described herein, preferably PA 6, the polymer PM2 is polyurethane and/or polyurea, preferably polyurea, described herein, and the solvent SO1 is a lactam, preferably caprolactam, described herein. Thus, the purity of the polymer blend PB2 and/or the polymer product PP1 can be increased.

In a further preferred embodiment the polymer PM1 and/or the polymer PM3 is/are a polyethylene terephthalate (PET) and/or a polyester and/or a cellulose based polymer.

According to the invention, the solubility of the polymer PM1 in the solvent S1 (g/L) is lower than the solubility of the polymer PM2 in the solvent S1 (g/L). Preferably, the solubility of the polymer PM1 in the solvent S1 is 4 g/L or less, preferably 3 g/L or less, more preferably 2 g/L or less, more preferably 1 g/L or less, more preferably 0.1 g/L or less. Thus, the separation is improved and the purity of the solvent S2 can be improved.

The polymer PM2, polymer PM3 and the polymer PM4 are not particularly limited. Preferably, the polymer PM2 and/or the polymer PM3 and/or the polymer PM4 is/are a polyurethane and/or polyurea, preferably a thermoset and/or thermoplastic polyurethane or polyurea; or mixtures thereof, more preferably a thermoplastic polyurethane or polyurea; or mixtures thereof, more preferably a thermoplastic polyurethane based on an aromatic isocyanate and/or a thermoplastic polyurethane based on aliphatic isocyanate. Especially, it is preferred that the polymer PM1 is a polyamide described herein, preferably PA 6, the polymer PM2 is a polyurethane and/or polyurea, preferably a polyurethane and/or a polyurea described herein, more preferably a polyurea described herein, the solvent SO1 is a lactam described herein, preferably caprolactam, preferably and the solvent SO2 is an alcohol and/or water, preferably water. Thus, the separation is very effective and the obtained polymer blend PB1 and solvent S2 exhibits improved purity.

The method or way to obtain the polyurethane described herein is not particularly limited. Preferably, the polymer PM2 and/or the polymer PM3 and/or the polymer PM4 is/are a polyurethane obtainable by a composition A and a composition B, wherein the composition A comprises a compound comprising at least two, preferably two or three, isocyanate groups, preferably wherein the composition A comprises a compound selected from aliphatic, cycloaliphatic and aromatic compounds comprising at least two, preferably two or three, isocyanate groups, more preferably wherein the compound is selected from 2,2′-, 2,4′- and 4,4′-methylene diphenyl diisocyanate (MDI) and homologs thereof, isophorone diisocyanate (IPDI), 2,4- and 2,6-toluene diisocyanate (TDI), tetramethylene diisocyanate, hexamethylene diisocyanate (HDI), naphthylene diisocyanate (NDI); and oligomers and mixtures thereof; and wherein composition B comprises a compound comprising at least two alcohol groups, preferably wherein the compound B is selected from an aliphatic, cycloaliphatic and aromatic compound comprising at least two alcohol groups, more preferably wherein the composition B comprises a compound selected from polyol, polyetherpolyole, polyesterpolyole, and mixtures thereof, more preferably wherein the composition B comprises a compound having a molecular weight of 400 g/mol to 15000 g/mol and is selected from polyol, polyetherpolyole, polyesterpolyole, and mixtures thereof, and/or wherein composition B comprises a compound comprising at least two functional groups reactive to isocyanate groups, preferably at least two functional groups selected from alcohol, amine; and mixtures thereof, and/or wherein composition B comprises water, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, hydroquinone bis(2-hydroxyethyl)ether, ethanolamine, diethanolamine, methyldiethanolamine, phenyldiethanolamine, glycerol, trimethylolpropane, 1,2,6-hexanetriol, triethanolamine, pentaerythritol, N,N,N′,N′-tetrakis(2-hydroxypropyl)ethylenediamine, diethyltoluenediamine, dimethylthiotoluenediamine; and mixtures thereof; optionally copolymerized with an epoxide compound, preferably ethylene oxide and/or propylene oxide.

According to the invention, the solubility of the polymer PM1 in the solvent S1 (g/L) is lower than the solubility of the polymer PM2 in the solvent S1 (g/L). Preferably, the solubility of the polymer PM2 and/or the polymer PM4 in the solvent S1 is 3 g/L or more, preferably 4 g/L or more, more preferably 5 g/L or more, more preferably 10 g/L or more, more preferably 15 g/L or more, more preferably 25 g/L or more, more preferably 50 g/L or more, more preferably 100 g/L or more, more preferably 200 g/L or more. As higher the solubility of the polymer PM2 in the solvent S1 as less solvent is needed. In addition, the inventors surprisingly recognized that if the solubility is 3 g/L or more, preferably 4 g/L or more, more preferably 5 g/L or more, more preferably 10 g/L or more, more preferably 15 g/L or more, more preferably 25 g/L or more, more preferably 50 g/L or more, more preferably 100 g/L or more, more preferably 200 g/L or more, the separation is very effective.

In a preferred embodiment, the polymer PM2 and/or the polymer PM4 is not a polyamide. In a preferred embodiment, the polymer PM2 and the polymer PM3 are the same and/or the polymer PM2 and the polymer PM4 are the same and/or the polymer PM3 and the polymer PM4 are the same, more preferably the polymer PM2, the polymer PM3 and the polymer PM4 are the same.

The polymer PM3 is not particularly limited. Since the polymer PM3 can be obtained by the methods described herein, any polymer can be obtained. Preferably, the polymer PM3 is a polymer selected from polyamide (PA), polyurethane (PU), low-density polyethylene (LDPE), high-density polyethylene (HDPE), polyethylene (PE), polypropylene (PP), polyvinyl chloride (PVC), polystyrene (PS), polytetrafluoroethylene (Teflon), thermoplastic polyurethanes (TPU), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO); and copolymers and mixtures thereof. In a preferred embodiment, the polymer PM1 and the polymer PM3 are the same.

In a preferred embodiment, the polymer blend PB1, preferably the polymer blend PB1 and/or polymer blend PB2, more preferably the polymer blend PB1 and/or the polymer blend PB2 and/or the solvent blend SO2, comprises one or more additive(s) A1. Herein, an additive may be anything except a polymer. Preferably, the additive(s) A1 is/are selected from fiber(s), antioxidating agent(s), stabilizer(s), lubricant(s), mineral(s), colorant(s), pigments, soot, talc, and mixtures thereof. In a preferred embodiment, the additive(s) A1 is/are compliant with at least one of the Gulf Cooperation Council Standardization Organization GSO 2231/2012, and/or GSO 839/1997, and/or GSO 1863/2013 standard; or is/are Halal certified, and/or Kosher certified, and/or HACCP certified. Especially, if the polymer blend PB1 comprises an additive, preferably a colorant, the inventors recognized that surprisingly also the additive, preferably the colorant, can be removed at least partially from the polymer blend PB1 with the method described herein.

According to the invention, the solvent S1 comprises a solvent SO1. Preferably, the solvent S1 comprises a solvent SO2, wherein the solvent SO1 and the solvent SO2 are not the same. The presence of the solvent SO2 influences the properties of the solvent S1 and thus, the separation of the polymer blend PB1, especially depending on the content of the solvent SO2 and/or the kind of the solvent SO2. In general, the presence of the solvent SO2 decreases the melting point of the solvent S1.

In a preferred embodiment, the solvent S1 does not contain dimethylformamide DMF, preferably dimethylformamide DMF, dimethylacetamide DMAc and/or N-Methyl-2-pyrrolidone NMP. The boiling points of these solvents is very high. Thus, the separation of the solvent S2 to obtain the polymer PM2 is improved.

The content of solvent SO1 and solvent SO2 (if present) in the solvent S1 is not particularly limited. In a preferred embodiment, the content of the solvent SO1 and/or, preferably and, the solvent SO2 in the solvent S1 is 20 weight-% or more, preferably 30 weight-% or more, more preferably 50 weight-% or more, more preferably 75 weight-% or more, more preferably 80 weight-% or more, more preferably 85 weight-% or more, more preferably 90 weight-% or more, more preferably 95 weight-% or more, more preferably 98 weight-% or more, more preferably wherein the solvent blend consists of the solvent SO1 and the solvent SO2, preferably the solvent SO1. Thus, the separation of the solvent S2 is simplified and consequently, the purity of the polymer PM2, obtained after separation of the solvent S2, is increased.

The miscibility of the solvents in the solvent blend is not particularly limited. The solvent blend might be an emulsion or a homogeneous mixture at the temperature used in the method described herein. Preferably, the solvent SO1 and the solvent SO2 are miscible, preferably at 25° C. and/or at the temperature used in the contacting step; and/or the solvent S1 is a homogeneous solvent blend, preferably at 25° C. and/or at the temperature used in the contacting step. Thus, the separation is improved.

The content of the solvent SO1 in the solvent S1 is not particularly limited. Preferably, in the following equation:

$$\frac{solvent SO 1 [ kg ]}{solvent SO 1 [ kg ] + solvent SO 2 [ kg ]} \geq x 1$$

x1 is 0.01, preferably 0.1, more preferably 0.2, more preferably 0.3, more preferably 0.4, more preferably 0.4, more preferably 0.5, more preferably 0.6, more preferably 0.7, more preferably 0.8, more preferably 0.9, more preferably 0.95, more preferably 0.97; and/or in the following equation:

$$\frac{solvent SO 1 [ kg ]}{solvent SO 1 [ kg ] + solvent SO 2 [ kg ]} \leq x 2$$

x2 is 0.99, preferably 0.97, more preferably 0.95, more preferably 0.9, more preferably 0.8, more preferably 0.7, more preferably 0.6, more preferably 0.5, more preferably 0.4, more preferably 0.3, more preferably 0.2, more preferably 0.1, more preferably 0.05. Especially, if the content of the solvent SO1 in the solvent S1 is high, i.e. x1 is 0.5, preferably 0.6, more preferably 0.7, more preferably 0.8, more preferably 0.9, more preferably 0.95, more preferably 0.97, the separation of the polymer blend PB1 is improved. This is particularly the case, if the solvent SO1 is caprolactam and the polymer PM2 is a polyurethane and/or a polyurea, preferably the polyurethane and/or a polyurea described herein, more preferably a polyurea described herein.

The content of the solvent SO2 in the solvent S1 is not particularly limited. Preferably, in the following equation:

$$\frac{solvent SO 2 [ kg ]}{solvent SO 1 [ kg ] + solvent SO 2 [ kg ]} \geq y 1$$

y1 is 0.01, preferably 0.05, more preferably 0.07, more preferably 0.10, more preferably 0.15, more preferably 0.2, more preferably 0.3, more preferably 0.4, more preferably 0.5, more preferably 0.6, more preferably 0.7, more preferably 0.8, more preferably 0.9, more preferably 0.95, more preferably 0.97; and/or in the following equation:

$$\frac{solvent SO 2 [ kg ]}{solvent SO 1 [ kg ] + solvent SO 2 [ kg ]} \leq y 2$$

y2 is 0.99, preferably 0.97, more preferably 0.95, more preferably 0.9, more preferably 0.8, more preferably 0.7, more preferably 0.6, more preferably 0.5, more preferably 0.4, more preferably 0.3, more preferably 0.2, more preferably 0.1, more preferably 0.05.

If the content of the solvent SO2 is high, i.e. y1 is 0.01, preferably 0.05, more preferably 0.07, more preferably 0.10, more preferably 0.15, more preferably 0.2, more preferably 0.3, more preferably 0.4, more preferably 0.5, more preferably 0.6, more preferably 0.7, more preferably 0.8, more preferably 0.9, more preferably 0.95, more preferably 0.97, the efficiency of the separation is improved, e.g. due to a reduction of the boiling point of the solvent S1. This is particularly the case, if the solvent SO1 is caprolactam, the solvent SO2 is alcohol, preferably methanol, and/or water, and the polymer PM2 is a polyurethane and/or a polyurea, preferably a polyurethane and/or a polyurea described herein, more preferably a polyurea described herein. However, if the content of the solvent SO2 is low, i.e. y2 is 0.5, preferably 0.4, more preferably 0.3, more preferably 0.2, more preferably 0.1, more preferably 0.05, the solubility of the polymer PM2 in the solvent S1 is increased and thus, the separation is increased.

In a preferred embodiment, the ratio [weight/weight] of the solvent SO1 to the solvent SO2 is 0.01 or more and 100 or less, preferably 0.03 or more and 30 or less, more preferably 0.05 or more and 5 or less, more preferably 0.10 or more and 1 or less, more preferably 0.15 or more and 0.50 or less. Thus, the efficiency of the separation is improved.

In a preferred embodiment, the solvent SO1 and/or, preferably and, the solvent SO2 is/are (a) protic solvent(s). Thus, the efficiency of the separation is improved. Herein, a protic solvent is a solvent which has a functional group from which (a) hydrogen atom(s) can be split off as protons (dissociation). A functional group is for example carboxylic acid, amid, amine, and alcohol.

The melting point of the solvent SO1 and the solvent SO2 is not particularly limited. Preferably, the melting point of the solvent SO1 is higher than the melting point of the solvent SO2. Thus, the melting point of the solvent blend SO1 comprising the solvent SO1 and the solvent SO2 is reduced. This is particularly true, if the solvent SO1 is caprolactam.

In a preferred embodiment, in the following equation:

$$[ MP ] A - [ MP ] B \geq z 1$$

wherein [MP]A is the melting point of the solvent SO1 in ° C., and
wherein [MP]B is the melting point of the solvent SO2 in ° C.,
z1 is 5° C., preferably 25° C., more preferably 50° C., more preferably 75° C., more preferably 100° C., more preferably 125° C., more preferably 150° C., more preferably 160° C.

Especially, if the temperature of the melting point of the solvent SO2 is significantly lower compared to the melting point of the solvent SO2, i.e. z1 is 5° C., preferably 25° C., more preferably 50° C., more preferably 75° C., more preferably 100° C., more preferably 125° C., more preferably 150° C., more preferably 160° C., the separation is very effective and costs are reduced.

In a preferred embodiment, the melting point of the solvent S1 is 0° C. or more, preferably 25° C. or more, more preferably 50° C. or more, more preferably 55° C. or more, more preferably 60° C. or more, more preferably 65° C. or more, more preferably 70° C. or more; and/or 250° C. or less, preferably 200° C. or less, more preferably 150° C. or less, more preferably 125° C. or less, more preferably 100° C. or less, more preferably 90° C. or less, more preferably 80° C. or less, more preferably 80° C. or less, more preferably 70° C. or less, more preferably 60° C. or less, more preferably 50° C. or less, more preferably 30° C. or less, more preferably 25° C. or less, more preferably 20° C. or less, more preferably 15° C. or less. If the temperature is low, e.g. 100° C. or less, more preferably 90° C. or less, more preferably 80° C. or less, more preferably 80° C. or less, more preferably 70° C. or less, more preferably 60° C. or less, more preferably 50° C. or less, more preferably 30° C. or less, more preferably 25° C. or less, more preferably 20° C. or less, more preferably 15° C. or less, the heat input can be reduced during the separation and thus, the costs for the separation are reduced.

The kind of the solvent SO1 is not particularly limited. Preferably, the solvent SO1 can be polymerized, preferably optionally together with monomer(s) MO1, and/or, MO2, and/or MO3, to obtain the polymer PM1. The inventors recognized that in some cases surprisingly at least some traces of the solvent SO1 remain in the separated product, e.g. in the polymer blend PB2 comprising the polymer PM1. Thus, if the solvent SO1 is a monomer and can be polymerized to obtain the polymer PM1, the influence of the solvent SO1 on the properties of the polymer blend PB2 is reduced.

In a preferred embodiment, the solvent SO1 comprises, preferably consists of, the elements C, O and H, preferably C, O, N and H and/or the solvent SO1 is an amide, preferably a lactam, preferably 2-pyrrolidone, 2-piperidone, caprolactam and/or laurolactam, more preferably caprolactam and/or laurolactam, more preferably caprolactam, more preferably ε-caprolactam. Particularly, if the solvent SO1 is lactam, preferably caprolactam, and the polymer PM1 is a polyamide described herein and the polymer PM2 is a polyurethane and/or a polyurea, preferably a polyurethane and/or a polyurea described herein, more preferably a polyurea described herein, the efficiency of the separation is improved.

The kind of the solvent SO2 is not particularly limited. Preferably, the solvent SO2 comprises the elements O and H, preferably C, O and H and/or the solvent SO2 comprises an —OH group, preferably is water and/or alcohol, preferably methanol, ethanol, propanol and/or water, more preferably water.

In another preferred embodiment, the solvent SO2 is selected from the group consisting of water and organic solvents having a octanol-water partition coefficient log K_{OW} in the range of from −1.6 to +1.6, preferably selected from the group consisting of water, C5 to C12 alkane, aliphatic C1 to C10 alcohol, C3 to C10 ketone, C2 to C10 cyclic ketone, HO—[C1 to C10 alkyl-O-]ₙ-H, with n being an integer in the range of from 2 to 1000, C1 to C10 alkyl-O—C3 to C10 alkyl ether, C3 to C10 cyclic ether, optionally substituted with one or more C1 to C6 alkyl group(s), C6 to C10 aromatic hydrocarbon, optionally substituted with one or more C1 to C6 alkyl group(s), C2 to C10 aliphatic ester, C8 to C11 aromatic ester, C5 to C10 cyclic carboxylic ester (lactone), C3 to C12 amide, preferably R1R2N—C(═O)—R3, wherein R1, R2 are independently a C1 to C4 alkyl group and R3 is selected from the group consisting of C1 to C9 alkyl group, C1 to C10 ester group and C1 to C6 ether group, C3 to C6 lactam, optionally substituted with one or more substituent selected from C1 to C6 alkyl group, C1 to C6 ester group and C1 to C6 ether group, and C5 imidazolidine, optionally substituted with one or more C1 to C6 alkyl group(s), C5 to C7 imidazolidone, optionally substituted with one or more C1 to C6 alkyl group(s).

The boiling point of the solvent SO2 is not particularly limited. Preferably, the boiling point of the solvent SO2 is 0° C. to 150° C., preferably 10° C. to 120° C., more preferably 20° C. to 110° C., more preferably 30° C. to 100° C., more preferably 50° C. to 90° C., more preferably 60° C. to 80° C. If the boiling point is low, e.g. 120° C. or less, preferably 110° C. or less, more preferably 100° C. or less, more preferably 90° C. or less, more preferably 80° C. or less, it is easier to remove the solvent SO2, for example by distillation, and thus the solvent SO1 can be easier recovered and also the purity of the polymer blend PB2 can be improved.

A person skilled in the art understands that all components present in the solvent S1 preferably are also present in the solvent S2. Thus, preferably the solvent S2 comprises the same solvents as the solvent S1 and/or the solvent S2 comprises solvent SO1, preferably and solvent SO2. Consequently, preferably the solvent S2 comprises one or more, preferably two, solvents selected from a list consisting of lactam, preferably caprolactam, methanol, ethanol, propanol, isopropanol, acetonitrile, ethyl acetate, acetone, and water; preferably lactam, preferably caprolactam, and water and/or methanol; more preferably lactam, preferably caprolactam, and water.

In a preferred embodiment, the polymer product PP1, PP2, PP3 and/or PP4 is/are a textile, a yarn, a monofilament, a foam, a granulate, a foil, an injection-moulded article, and/or an extruded film; and mixtures thereof, preferably a textile. In a preferred embodiment, the polymer product PP1, PP2, PP3 and/or PP4 comprise(s) at least 1% of the polymer PM1 and/or the polymer PM3, preferably obtained by or obtainable by the method described herein. In a preferred embodiment, the polymer product PP1, PP2, PP3 and/or PP4 comprise(s) the polymer PM1, PM2, PM3 and/or PM4. In a preferred embodiment, the polymer blend PB2 and/or the polymer product PP1, PP2, PP3 and/or PP4 is/are amorphous. In a preferred embodiment, the polymer blend PB2 and/or the polymer product PP1, PP2, PP3 and/or PP4 is/are semicrystalline.

In a preferred embodiment, the recycling content in the polymer product PP1, PP2, PP3 and/or PP4 is/are 5 weight-% or more, preferably 10 weight-% or more, more preferably 20 weight-% or more, more preferably 25 weight-% or more, more preferably 30 weight-% or more, more preferably 35 weight-% or more, more preferably 50 weight-% or more, more preferably 75 weight-% or more, more preferably 80 weight-% or more, more preferably about 100 weight-%.

In a preferred embodiment, the monomer(s) MO1 and/or MO3 is/are a lactam, preferably caprolactam, more preferably ε-caprolactam.

In a preferred embodiment, the monomer MO1 and/or the monomer MO2 and/or the monomer MO3 and/or the monomer MO4 is a monomer which can be polymerized, optionally together with a further monomer, to obtain a polymer selected from polyamide (PA), polyurethane (PU), low-density polyethylene (LDPE), high-density polyethylene (HDPE), polyethylene (PE), polypropylene (PP), polyvinyl chloride (PVC), polystyrene (PS), polytetrafluoroethylene (Teflon), thermoplastic polyurethanes (TPU), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO); and copolymers and mixtures thereof.

In a preferred embodiment, the polymer blend PB2 and/or the polymer product PP1, PP2, PP3 and/or PP4 exhibit(s) improved workability; and/or the polymer blend PB2 and/or the polymer product PP1, PP2, PP3 and/or PP4 exhibit(s) improved skin sensitivity; and/or the polymer blend PB2 and/or the polymer product the polymer product PP1, PP2, PP3 and/or PP4 exhibit(s) improved carbon footprint. Thus, the areas of applications are extended.

Solvent S1 and/or solvent S2 can be a single solvent or solvent blend of two or more solvents.

In a preferred embodiment, the solvent S1 is a solvent blend SB1.

In a preferred embodiment, the solvent S1 consists of a/the solvent SO1.

In a preferred embodiment, the solvent S1 comprises, preferably consists of, a/the solvent SO1 and the solvent SO2.

In a preferred embodiment, the solvent S2 comprises, preferably consists of, solvent SO1, preferably solvent SO1, polymer PM2 and one or more additive(s), more preferably solvent SO1, solvent SO2, polymer PM2 and one or more additive(s), more preferably solvent SO1, solvent SO2, polymer PM1, polymer PM2 and one or more additive(s).

In a preferred embodiment, the solvent S2 is a solvent blend SB2.

In a preferred embodiment, the solvent S1 and/or, preferably and, the solvent S2 do(es) not comprise dimethylformamide DMF, dimethylacetamide DMAc, 1-methylpyrrolidin-2-one NMP, 2-pyrrolidone, 2-piperidone, 2,2′-diaminodiethylamine (DETA), diisopropylamine, pyridine, pentylamine, N,N-diethylethanamine, diethylengylcol, tetrahydrofuran THF, hexamethylphosphoramide HMPA, acetonitrile, dimethylsulfoxide DMSO, and/or, preferably and, 1,4-butanediol.

In a preferred embodiment, the polymer PM2 and/or the polymer PM3 and/or the polymer PM4 comprises, preferably consists of, polyurethane and/or polyurea, more preferably polyurea, more preferably a copolymer comprising polyurea, more preferably polyether-polyurea copolymer.

In a preferred embodiment, the solvent SO1 is a monoalcohol, preferably methanol and/or ethanol, more preferably methanol.

In a preferred embodiment, the solvents in solvent S1 and the solvents in solvent S2 are the same. Thus, no further solvent is added or removed during the contacting and separating step.

In a preferred embodiment, the shape of the polymer product PP1 and/or the polymer product PP2 and/or the polymer product PP3 and/or the polymer product PP4 is/are a foil, granulate, powder, laminate, foam, molded article, pipe.

In a preferred embodiment, the polymer product PP1 and/or the polymer product PP2 and/or the polymer product PP3 and/or the polymer product PP4 is/are or is/are a part of:
a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
a cloth; preferably shirt, trousers, pullover, boot, shoe, shoe sole, tight or jacket;
an electrical part; preferably electrical or electronic passive or active component, circuit breaker, circuit board, printed circuit board, terminal block, housing component, foil, line, switch, switch gear, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
a packaging for the food industry; preferably mono- or multi-layer blown film, cast film (mono- or multi-layer), biaxially stretched film, or laminating film; or
a part of a construction; preferably a rotor blade, insulating material, frame, housing, wall, coating, or separating wall.

In a preferred embodiment, the content of the solvent SO1 in the solvent S1 and/or, preferably and, the solvent S2 is 20 weight-% or more, preferably 30 weight-% or more, more preferably 50 weight-% or more, more preferably 75 weight-% or more, more preferably 80 weight-% or more, more preferably 85 weight-% or more, more preferably 90 weight-% or more, more preferably 95 weight-% or more, more preferably 98 weight-% or more, more preferably wherein the solvent blend consists of the solvent SO1 and the solvent SO2, preferably the solvent SO1; and/or

the content of the solvent SO1 in the solvent S1 and/or, preferably and, the solvent S2 is 100 weight-% or less, preferably 99 weight-% or less, more preferably 95 weight-% or less, more preferably 90 weight-% or less, more preferably 85 weight-% or less, more preferably 80 weight-% or less, more preferably 75 weight-% or less, more preferably 70 weight-% or less, more preferably 50 weight-% or less.

In a preferred embodiment, the content of the solvent SO2 in the solvent S1 and/or, preferably and, the solvent S2 is 1 weight-% or more, preferably 2 weight-% or more, more preferably 5 weight-% or more, more preferably 8 weight-% or more, more preferably 10 weight-% or more, more preferably 15 weight-% or more, more preferably 20 weight-% or more, more preferably 30 weight-% or more, more preferably 40 weight-% or more, more preferably 50 weight-% or more; and/or

the content of the solvent SO2 in the solvent S1 and/or, preferably and, the solvent S2 is 100 weight-% or less, preferably 50 weight-% or less, more preferably 30 weight-% or less, more preferably 25 weight-% or less, more preferably 22 weight-% or less, more preferably 18 weight-% or less, more preferably 15 weight-% or less, more preferably 12 weight-% or less, more preferably 10 weight-% or less.

In a preferred embodiment, in the solvent S1 and/or, preferably and, the solvent S2 a ratio (weight/weight) of the content of the solvent SO2 to the content of the solvent SO1 is 0.01 to 0.50, preferably 0.05 to 0.40, more preferably 0.10 to 0.30, more preferably 0.15 to 0.25.

In a preferred embodiment, the polymer blend PB1 and/or the polymer blend PB2 and/or the polymer product comprises, preferably consist of, polymer PM1, polymer PM2 and one or more additive(s).

In a preferred embodiment, the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 91 weight-% or more, more preferably 95 weight-% or more, more preferably 96 weight-% or more, polymer PM1 with regard to the solvent S2, the polymer blend PB1, the polymer blend PB2 and/or the polymer product PP1.

In a preferred embodiment, the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, more preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM1 with regard to the solvent S2, the polymer blend PB1, the polymer blend PB2 and/or the polymer product PP1. Especially, if the solvent S2 comprise(s) 5 weight-% or less, preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM1 with regard to the solvent S2, the separation is very effective.

In a preferred embodiment, the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 91 weight-% or more, more preferably 95 weight-% or more, more preferably 96 weight-% or more, polymer PM2 with regard to the solvent S2, the polymer blend PB1, the polymer blend PB2 and/or the polymer product PP1.

In a preferred embodiment, the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, more preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM2 with regard to the solvent S2, the polymer blend PB1, the polymer blend PB2 and/or the polymer product PP1. Especially, if the polymer blend PB2 (or the polymer product PP1) comprise(s) 5 weight-% or less, preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM2 with regard to the polymer blend PB2 (or the polymer product PP1), the separation is very effective. In a further preferred embodiment, the content of polymer PM2 in the polymer blend PB2 is below the detection limit. This can be achieved by either repeating the method described herein several times or using a very large amount of solvent S1 as described herein. Thus, in a further preferred embodiment, the polymer blend PB2 is a polymer composition PC1 comprising, preferably consisting of, polymer PM1 and one or more additives.

If not further specified, preferably the following methods are used, and definitions apply.

Tm and/or Tg is/are preferably obtained by DSC. DSC measurements are done according to DIN EN ISO 11357 using heat/cooling rate of 20K/min in a temperature range of 0-280° C. on a Perkin Elmer DSC 8000.

IR spectra are obtained by IR spectrometers equipped with ATR units (Thermo Nicolet iS50). For measurement the samples are placed directly onto the ATR crystal without further preparation and are fixed with the unit's stamp. All measurements are performed at room temperature (25° C.) using 32 scans and a resolution of 4 cm¹.

Mass average molar mass Mw and number average molar mass are preferably obtained as follows: An Agilent 1100 Series is used as an integrated instrument, including 2×PL HFIPgel 300×7.5 mm+1 HFIP-LG Guard 50×7.5 mm as well as a DRI Agilent 1100 detector. All calibrations are carried out using PMMA standards with molecular weights between 800 g/mol and 2200000 g/mol purchased from Polymer Standards Service. Flow is 1 ml/min. Sample concentration is 1.5 mg/mL. Eluent is HFIP+0.05% potassium trifluoroacetate.

Content of a polymer is preferably obtained as follows: The content of a/the polymer(s), e.g. polyamide (PA) in the samples is determined by quantitative ¹H-NMR spectroscopy. All NMR spectra are recorded at T=298.2 K on a Bruker Avance III 400 spectrometer operating at 400.33 MHz for ¹H. The spectrometer is equipped with a 5 mm z-gradient broadband observe smartprobe. ¹H spectra are recorded under quantitative conditions using the zg30 pulse program with a sampling of 128k data points, the relaxation delay D1 is chosen as 45 seconds for the solvent hexafluoro-2-propanol (HFIP). 8 transients are summed up per spectrum. For processing in Bruker TopSpin 4.1.4 software, 128k data points are used, an exponential window function with a line broadening of 0.3 Hz is applied. Automatic baseline correction with a polynomial of 3 is performed, phase correction and integration is performed manually by the user.

For the determination of PA from fabric, samples are prepared by exact weighting (Mettler-Toledo XP205DR analytical balance) of the internal standard 1,2,4,5-tetrachloro-3-nitrobenzene (Tecna) and the analyte in a suitable vial, followed by dissolution in 2 mL of HFIP. Chemical shifts are referenced to hexafluoro-2-propanol-d2 (HFIP, δ (HFIP)=4.25 ppm). The samples are transferred into 5 mm NMR tubes for measurement. Deuterated solvent HFIP is purchased from Euriso-Top GmbH. Tecna (certified internal standard) is purchased from Sigma-Aldrich. All solvents and internal standards are used as received.

The content of test item is calculated by using the following equation:

$$w = \frac{{E}_{St} * {I}_{K} * {M}_{K} * {A}_{St} * {R}_{St}}{{E}_{P} * {I}_{St} * {M}_{St} * {A}_{K}}$$

In this equation: w=mass fraction of the analyte in the sample [g/100 g], Iₖ=peak intensity of the analyte, I_{St}=peak intensity of the standard, E_{P}=sample mass [g], E_{St}=mass of the standard [g], A_{K}=protons/molecule of analyte, A_{St}=protons/molecule of the standard, M_{K}=molecular weight of the analyte [g/mol], M_{St}=molecular weight of the standard [g/mol], and R_{St}=purity of the standard [g/100 g].

For quantification triplicate determinations are carried out. In particular, the evaluation of PA is performed by using 1 proton/molecule of the internal standard Tecna (at about 7.6 ppm) and 2 selected protons/molecule of the analyte PA (at about 2.2 ppm).

The content of amino end groups and/or carboxylic end groups is/are preferably obtained as follows: For determination of the content of the amino end groups (AEG), the test specimens (1 g) are dissolved in a phenol-methanol mixture (75:25 v/v; 30 mL) at 85° C. and afterwards potentiometrically titrated against 0.02 mol/I HCl (pH electrode detection). For determination of carboxylic end groups (CEG) the samples are dissolved in 30 ml benzyl alcohol and titrated against 0.05N alcoholic KOH (visual detection).

The content of extractables is determined by methanol extraction according to DIN ISO 6427. The test specimens are extracted in boiling methanol for 16 h. Extractables dissolved in methanol are determined by gravimetry.

The relative viscosity is determined by viscosity measurement of 1 g sample in 100 mL solution at 20° C. in an ubbe lohde viscosimeter according to ISO 307. 96% H₂SO₄ is used as solvent. The relative viscosity is the coefficient of the viscosity of the solution and the viscosity of the sulfuric acid.

The solubility of a polymer, e.g. polymer PM1 and PM2 in a solvent, e.g. the solvent S1, is preferably determined as follows: First a supersaturated solution, e.g. 5 L, of the polymer, e.g. polymer PM1 or PM2, and the solvent, e.g. the solvent S1, is prepared at ambient conditions (1 bar, 25° C.) by stirring an excess of a polymer, e.g. a polymer granulate, in the solvent until an equilibrium is obtained, e.g. after 7 days. Thereafter, the supersaturated solution is separated by filtration to obtain a filter cake and a filtrate. Finally, a defined volume, e.g. 1 L, is taken from the filtrate and the solvent from the defined volume is completely removed by evaporation to obtain a residue. The solubility is the ratio of the residue (g) and the volume (L) taken from the filtrate.

Herein, caprolactam is preferably ε-caprolactam. The definitions and preferred embodiments for the method described herein also apply for the use, polymer, polymer blend, polyol composition and/or polymer product and vice versa. This includes that all definitions and preferred embodiments for the polymer product PP1 also apply for the polymer products PP2, PP3 and PP4; and vice versa. A person skilled in the art knows that every solvent may comprise impurities, e.g. other solvents, salts or organic compounds. Preferably, the purity of the solvents, especially the solvent SO1 and the solvent SO2, is 90 weight-% or more, preferably 95 weight-% or more, more preferably 98 weight-% or more, more preferably 99 weight-% or more, more preferably 99.9 weight-% or more, more preferably 99.99 weight-% or more. If not stated otherwise, the recycling content is preferably determined according to DIN EN 15343:2008-02. If not stated otherwise, the mass of recycled materials in the product is preferably determined based upon the weight determined by mass balance, preferably and the free attribution method. If not stated otherwise, preferably standard ambient temperature and pressure are used or applied, i.e. 25° C. and 1 bar.

Herein, the solvent S1 is preferably either a solvent SO1 or a solvent blend SB1 comprising, preferably consisting of, solvent SO1 and solvent SO2. In addition, solvent S2 herein preferably comprises, preferably consists of, solvent SO1 or a solvent blend SB1 comprising, preferably consisting of, solvent SO1 and solvent SO2, and polymer PM2, more preferably and polymer PM1 and/or one or more additive(s).

In summary, embodiments and preferred embodiments are the following items. The scope of protection is defined by the claims. The combination of two or more items and/or embodiments, e.g. 3, 4 or 8 items is further preferred. Definitions and general statements herein preferably also apply for the following items and preferred items. Preferably, the steps described in the items below are conducted, especially if present in the claims, in the order of the items below and/or as depicted in the attached Figures.
1. A method, comprising the following steps, preferably in this order:
   providing a polymer blend PB1 and a solvent S1,
   wherein the polymer blend PB1 comprises:
      i) a polymer PM1, and
      ii) a polymer PM2, and
      wherein the solvent S1 comprises:
      i) a solvent SO1, and
      ii) preferably a solvent SO2, and
      preferably wherein the solvent SO1 and the solvent SO2 are not the same, and
      wherein the solubility of the polymer PM1 in the solvent S1 (g/L) is lower than the solubility of the polymer PM2 in the solvent S1 (g/L); and
      contacting the polymer blend PB1 with the solvent S1 to obtain a mixture MI1; and
      preferably separating the mixture MI1 to obtain a polymer blend PB2 comprising the polymer PM1 and a solvent S2 comprising the polymer PM2.
2. Method according to any one of the preceding items,
   wherein, in the contacting step, one or more of the following conditions is/are fulfilled:
   i) the polymer blend PB1 and the solvent S1 are at least once stirred and/or sonicated, preferably for a time t1;
   ii) the polymer blend PB1 and the solvent S1 are in contact for a/the time t1;
   iii) the polymer blend PB1 and the solvent S1 are at least once heated to a temperature T1, preferably for a/the time t1
   wherein the time t1 is 0.1 seconds or more and 7 days or less, preferably 1 min or more and 48 hours or less, more preferably 1 hour or more and 32 hours or less, more preferably 10 hours or more and 20 hours or less; and
   wherein the temperature T1 is 0° C. or more and less than Tm, measured by DSC, of the polymer PM1, preferably 5° C. or more and 250° C. or less, more preferably 10° C. or more and 200° C. or less, more preferably 12° C. or more and 85° C. or less, more preferably 15° C. or more and 75° C. or less, more preferably 17° C. or more and 65° C. or less, more preferably 20° C. or more and 60° C. or less, more preferably 25° C. or more and 55° C. or less, more preferably 30° C. or more and 50° C. or less.
3. Method according to any one of the preceding items, wherein the method further comprises the step:
   separating the mixture MI1 to obtain a polymer blend PB2 comprising the polymer PM1 and a solvent S2 comprising the polymer PM2.
4. Method according to any one of the preceding items,
   wherein separating the mixture MI1 to obtain a polymer blend PB2 comprising the polymer PM1 and a solvent S2 comprising the polymer PM2 is a physical separation method, preferably filtering and/or decanting the mixture MI1 to obtain the polymer blend PB2 comprising the polymer PM1 and the solvent S2 comprising the polymer PM2.
5. Method according to any one of the preceding items,
   wherein the ratio [weight/weight] of the polymer blend PB1 to the solvent S1 during the contacting step is 0.001 or more and 1000 or less, preferably 0.005 or more and 50 or less, more preferably 0.01 or more and 25 or less, more preferably 0.02 or more and 15 or less, more preferably 0.03 or more and 10 or less, more preferably 0.04 or more and 5 or less, more preferably 0.05 or more and 4 or less, more preferably 0.06 or more and 3 or less, more preferably 0.07 or more and 2 or less, more preferably 0.08 or more and 1 or less, more preferably 0.09 or more and 0.5 or less, more preferably 0.10 or more and 0.15 or less, more preferably about 0.1.
6. Method according to any one of the preceding items, wherein the method further comprises the step(s):
   washing the polymer blend PB2 with the solvent S1 to obtain a polymer blend PB2, which has been washed; and/or
   drying the polymer blend PB2,
   preferably by contact drying, convection drying, radiation drying, and/or
   wherein the drying step is performed under one or more of the following conditions:
      a pressure of 0.01 mbar or more and 1013 mbar or less, preferably 0.05 mbar or more and 500 mbar or less, more preferably 0.1 mbar or more and 200 mbar or less;
      a temperature of 0° C. or more and less than Tm, measured by DSC, of the polymer PM1, preferably 15° C. or more and 250° C. or less, more preferably 20° C. or more and 180° C. or less, more preferably 40° C. or more and 130° C. or less, more preferably 50° C. or more and 100° C. or less, and
      in an atmosphere having at least 90 volume-%, preferably at least 95 volume-%, more preferably at least 98 volume-%, more preferably about 100 volume-%, nitrogen.
7. Method according to any one of the preceding items, wherein the method is a method for the treatment of a polymer blend PB1, and/or for recycling of a polymer blend PB1, and/or for producing a monomer, preferably monomer MO1 and/or monomer MO2 and/or monomer MO3, and/or a polymer, preferably a polymer PM3 and/or a polymer PM4, and/or a polymer product, preferably a polymer product PP1 and/or a polymer product PP2 and/or a polymer product PP3 and/or a polymer product PP4, and/or a polyol composition, preferably a polyol composition PC1.
8. Method according to any one of the preceding items, wherein the method further comprises the step:
   converting the solvent S2 to obtain a monomer, preferably monomer MO1 and/or monomer MO2; and/or a polymer, preferably a polymer PM3 and/or a polymer PM4; and/or a polymer product, preferably a polymer product PP1 and/or a polymer product PP2 and/or a polymer product PP3 and/or a polymer product PP4; and/or a polyol composition, preferably a polyol composition PC1.
9. Method according to any one of the preceding items, wherein the converting step comprises the following step:
   adding of water to the solvent S2 until the polymer PM2 precipitates to obtain the polymer PM4.
10. Method according to any one of the preceding items, wherein the converting step comprises the following step:
   removing of the solvent; preferably the solvent SO1, more preferably the solvent SO1 and the solvent SO2; from the solvent S2 to obtain the polymer PM4.
11. Method according to any one of the preceding items, preferably wherein the polymer PM2 and/or the polymer PM4 is/are a polyurethane and/or a polyurea, preferably a polyurea, wherein the converting step comprises the following step:
   depolymerizing the polymer PM4, preferably wherein the depolymerization is carried out by a method selected from hydrolysis, glycolysis, hydrogenation or by aminolysis, to obtain a mixture MI2 comprising monomer MO2, preferably and a polyol composition PC1.
12. Method according to any one of the preceding items, preferably wherein the polymer PM2 and/or the polymer PM4 is/are a polyurethane and/or a polyurea, preferably a polyurea, wherein the converting step comprises the following step:
   sorting and/or purifying and/or separating the mixture MI2, obtained in the depolymerization of the polymer PM4, to obtain the monomer MO2 and/or the polyol composition PC1.
13. Method according to any one of the preceding items, wherein the converting step comprises the following step(s):
   polymerizing the monomer MO2, preferably wherein monomer MO2 is comprises an isocyanate group or an amine derivative thereof, and a molecule containing an OH-group to obtain the polymer PM3, preferably wherein the polymer PM3 is a polyurethane and/or a polyurea, preferably a polyurea; and/or
   polymerizing the polyol composition PC1 and a monomer containing a group reactive with an OH-group, preferably a monomer containing an isocyanate group;
optionally together with (a) further monomer(s) MO4, and/or optionally together with (an) additive(s) A1; to obtain the polymer PM3, preferably wherein the polymer PM3 is a polyurethane and/or a polyurea, preferably a polyurea.
14. Method according to any one of the preceding items, wherein the method further comprises the step:
   converting the polymer blend PB2 to obtain a monomer, preferably monomer MO1 and/or monomer MO3; and/or a polymer, preferably a polymer PM3; and/or a polymer product, preferably a polymer product PP1 and/or a polymer product PP2 and/or a polymer product PP3 and/or a polymer product PP4.
15. Method according to any one of the preceding items, wherein the converting step comprises the following step(s):
   biodegrading the polymer blend PB2 and/or the solvent S2 and/or the polymer PM4 to obtain a biomass BM1;
   optionally converting the biomass BM1 in a monomer precursor MP1; and
   converting the biomass BM1 and/or the monomer precursor MP1 to obtain a monomer MO1.
16. Method according to any one of the preceding items, wherein the converting step comprises the following steps:
   pyrolyzing the polymer blend PB2 and/or the solvent S2 and/or the polymer PM4 to obtain a pyrolysis oil and/or pyrolysis gas PY1;
   steam cracking the pyrolysis oil and/or pyrolysis gas PY1 to obtain a monomer precursor MP1; and
   converting the monomer precursor MP1 to obtain a monomer MO1.
17. Method according to any one of the preceding items, wherein the converting step comprises the following steps:
   depolymerizing the polymer blend PB2 to obtain a mixture MI3 comprising at least one monomer MO3; and
   preferably sorting and/or purifying and/or separating the mixture MI3 to obtain a monomer MO3.
18. Method according to any one of the preceding items, wherein the converting step comprises the following steps:
   polymerizing the mixture MI2 and/or mixture MI3 and/or monomer MO1 and/or monomer MO2 and/or monomer MO3; optionally together with (a) further monomer(s) MO4, and/or optionally together with (an) additive(s) A1; to obtain the polymer PM3.
19. Method according to any one of the preceding items, wherein the converting step comprises the following step:
   forming the polymer PM3 and/or the polymer PM4 and/or the polymer blend PB2, preferably together with (a) further polymer(s) and/or additive(s), to obtain a polymer product, preferably the polymer product PP1 and/or the polymer product PP2 and/or the polymer product PP3 and/or the polymer product PP4.
20. Method according to any one of the preceding items, wherein the method further comprises the step:
   repeating the previous steps one or more times.
21. Method according to any one of the preceding items, wherein the method further comprises one or more of the following step(s):
   repeating the method according to any one of the preceding items one or more times, to obtain a polymer product PP2, preferably wherein the content of the polymer product PP1 in the polymer product PP2 is a content CO1,
   recycle the polymer product PP1 one or more times to obtain a polymer product PP3, preferably wherein the content of the polymer product PP1 in the polymer product PP3 is a/the content CO1,
   recycle the polymer product PP1 one or more times to obtain a recycled material RM1 and converting or forming the recycled material RM1 to obtain a polymer product PP4 comprising the recycled material RM1, preferably wherein the content of the polymer product PP1 and/or the recycled material RM1 in the polymer product PP4 is a/the content CO1; and
   wherein the content CO1 is 1 weight-% or more, preferably 2 weight-% or more, more preferably 5 weight-% or more, more preferably 15 weight-% or more, more preferably 30 weight-% or more, more preferably 40 weight-% or more, more preferably 60 weight-% or more, more preferably 80 weight-% or more, more preferably 90 weight-% or more, more preferably 95 weight-% or more; and/or, preferably and,
   preferably wherein the content CO1 is 100 weight-% or less, preferably 95 weight-% or less, more preferably 90 weight-% or less, more preferably 50 weight-% or less, more preferably 25 weight-% or less, more preferably 10 weight-% or less; and
   preferably wherein the polymer product PP1 and the polymer product PP2, PP3, and/or PP4 are the same.
22. Method according to any one of the preceding items, wherein the method further comprises the step:
   certifying the polymer PM1, PM2, PM3 and/or PM4 and/or the polymer blend PB2 and/or the polymer product PP1, PP2, PP3 and/or PP4 as circular in accordance with a standard or protocol, preferably based on identity preservation and/or segregation and/or mass balance and/or book and claim chain of custody models, preferably based on mass balance, preferably the International Sustainability and Carbon Certification (ISCC) standard.
23. Polymer PM4, obtained by or obtainable by the method according to any one of the preceding items.
24. Use of the polymer PM4 according to any one of the preceding items and/or obtained by or obtainable by the method according to any one of the preceding items for the production of a polymer, preferably polymer product PP1, and/or in a recycling process.
25. Polyol composition PC1, obtained by or obtainable by the method according to any one of the preceding items.
26. Use of the polyol composition PC1 according to any one of the preceding items and/or obtained by or obtainable by the method according to any one of the preceding items for the production of a polymer, preferably polymer product PP1, and/or in a recycling process.
27. Polymer blend PB2, obtained by or obtainable by the method according to any one of the preceding items, preferably comprising the polymer PM1.
28. Use of the polymer blend PB2 according to any one of the preceding items and/or obtained by or obtainable by the method according to any one of the preceding items for the production of a polymer, preferably polymer product PP1, and/or in a recycling process.
29. Polymer PM3 obtained by or obtainable by the method according to any one of the preceding items.
30. Use of the polymer PM3 according to any one of the preceding items and/or obtained by or obtainable by the method according to any one of the preceding items for the production of a polymer, preferably polymer product PP1, and/or in a recycling process.
31. Polymer product PP1, PP2, PP3 and/or PP4, obtained by or obtainable by the method according to any one of the preceding items.
32. Polymer product PP1, PP2, PP3 and/or PP4, wherein the polymer product PP1, PP2, PP3 and/or PP4 comprises, preferably consists of, the polymer blend PB2 and/or the polymer PM1, PM2, PM3 and/or PM4, preferably obtained by or obtainable by the method according to any one of the preceding items; preferably and one or more additive(s) A1.
33. Use of the polymer product PP1, PP2, PP3 and/or PP4, preferably according to any one of the preceding items, in a recycling process, preferably a mechanical recycling process.
34. The method, use, polymer, polymer blend, polyol composition and/or polymer product, according to any one of the preceding items, preferably wherein the polymer blend PB2 and/or the polymer product PP1, PP2, PP3 and/or PP4 comprise(s) a/the polymer PM1, more preferably a polyamide,
   wherein the polymer blend PB2 and/or the polymer product PP1, PP2, PP3 and/or PP4 exhibit(s) a peak, preferably a peak indicating a v(C═O)-vibration, at 1600 cm⁻¹ or more and 1800 cm⁻¹ or less, preferably 1630 cm⁻¹ or more and 1680 cm⁻¹ or less, in an IR-spectrum; and/or
   wherein the polymer blend PB2 and/or the polymer product PP1, PP2, PP3 and/or PP4 exhibit(s) a peak, preferably a peak indicating a v(C—H) and/or δ(C—N—H) vibration, at 1450 cm⁻¹ or more and 1600 cm⁻¹ or less, preferably 1530 cm⁻¹ or more and 1570 cm⁻¹ or less, in an IR-spectrum; and/or
   wherein the polymer blend PB2 and/or the polymer product PP1, PP2, PP3 and/or PP4 exhibit(s) a peak, preferably a peak indicating a v(C—H) vibration, at 2500 cm⁻¹ or more and 3500 cm⁻¹ or less, preferably 2700 cm⁻¹ to 3200 cm⁻¹, in an IR-spectrum.
35. The method, use, polymer, polymer blend, polyol composition and/or polymer product, according to any one of the preceding items, wherein the mass average molar mass Mw of the polymer blend PB2 and/or the polymer product PP1 is/are 1.00*10⁴ or more, preferably 5.00*10⁴ or more, more preferably 5.40*10⁴ or more, more preferably 5.80*10⁴ or more, more preferably 6.30*10⁴ or more, more preferably 6.80*10⁴ or more, more preferably 7.10*10⁴ or more, more preferably 7.30*10⁴ or more.
36. The method, use, polymer, polymer blend, polyol composition and/or polymer product, according to any one of the preceding items, wherein the mass average molar mass Mw of the polymer blend PB2 and/or the polymer product PP1 is/are 1.00*10⁵ or less, preferably 8.00*10⁴ or less, more preferably 7.50*10⁴ or less, more preferably 7.40*10⁴ or less, more preferably 7.00*10⁴ or less, more preferably 6.70*10⁴ or less, more preferably 6.50*10⁴ or less, more preferably 6.30*10⁴ or less, more preferably 6.10*10⁴ or less, more preferably 5.85*10⁴ or less, more preferably 5.70*10⁴ or less, more preferably 5.50*10⁴ or less, more preferably 5.30*10⁴ or less, more preferably 5.10*10⁴ or less.
37. The method, use, polymer, polymer blend, polyol composition and/or polymer product, according to any one of the preceding items, wherein the number average molar mass Mn of the polymer blend PB2 and/or the polymer product PP1 is/are 2.00*10⁴ or more, preferably 2.10*10⁴ or more, more preferably 2.20*10⁴ or more, more preferably 2.30*10⁴ or more, more preferably 2.40*10⁴ or more, more preferably 2.48*10⁴ or more, more preferably 2.50*10⁴ or more, more preferably 2.60*10⁴ or more, more preferably 2.65*10⁴ or more, more preferably 2.70*10⁴ or more.
38. The method, use, polymer, polymer blend, polyol composition and/or polymer product, according to any one of the preceding items, wherein the number average molar mass Mn of the polymer blend PB2 and/or the polymer product PP1 is/are 4.00*10⁴ or less, preferably 3.00*10⁴ or less, more preferably 2.70*10⁴ or less, more preferably 2.65*10⁴ or less, more preferably 2.60*10⁴ or less, more preferably 2.55*10⁴ or less, more preferably 2.50*10⁴ or less, more preferably 2.46*10⁴ or less.
39. The method, use, polymer, polymer blend, polyol composition and/or polymer product, according to any one of the preceding items, preferably wherein the polymer PM1 is a polyamide and/or preferably wherein the polymer blend PB1 and/or the polymer blend PB2 comprise(s) an additive, preferably a colorant; wherein the content of amino end groups in the polymer blend PB2 and/or the polymer product PP1 is/are 1 mmol/kg or more, preferably 2 mmol/kg or more, more preferably 3 mmol/kg or more, more preferably 4 mmol/kg or more, more preferably 5 mmol/kg or more, more preferably 6 mmol/kg or more, more preferably 7.0 mmol/kg or more, more preferably 7.2 mmol/kg or more, more preferably 7.4 mmol/kg or more, more preferably 7.6 mmol/kg or more, more preferably 7.8 mmol/kg or more, more preferably 8.0 mmol/kg or more, more preferably 8.2 mmol/kg or more, more preferably 9.0 mmol/kg or more, more preferably 15 mmol/kg or more.
40. The method, use, polymer, polymer blend, polyol composition and/or polymer product, according to any one of the preceding items, preferably wherein the polymer PM1 is a polyamide and/or preferably wherein the polymer blend PB1 and/or the polymer blend PB2 comprise(s) an additive, preferably a colorant; wherein the content of amino end groups in the polymer blend PB2 and/or the polymer product PP1 is/are 100 mmol/kg or less, preferably 75 mmol/kg or less, more preferably 50 mmol/kg or less, more preferably 40 mmol/kg or less, more preferably 30 mmol/kg or less, more preferably 20 mmol/kg or less, more preferably 10 mmol/kg or less, more preferably 9.0 mmol/kg or less, more preferably 8.5 mmol/kg or less, more preferably 8.2 mmol/kg or less, more preferably 8.0 mmol/kg or less, more preferably 7.5 mmol/kg or less, more preferably 7.4 mmol/kg or less, more preferably 7.3 mmol/kg or less, more preferably 7.2 mmol/kg or less.
41. The method, use, polymer, polymer blend, polyol composition and/or polymer product, according to any one of the preceding items, preferably wherein the polymer PM1 is a polyamide and/or preferably wherein the polymer blend PB1 and/or the polymer blend PB2 comprise(s) an additive, preferably a colorant; wherein the content of carboxyl end groups in the polymer blend PB2 and/or the polymer product PP1 is/are 1 mmol/kg or more, preferably 25 mmol/kg or more, more preferably 50 mmol/kg or more, more preferably 60 mmol/kg or more, more preferably 65 mmol/kg or more, more preferably 66 mmol/kg or more, more preferably 70 mmol/kg or more, more preferably 73.0 mmol/kg or more, more preferably 73.2 mmol/kg or more, more preferably 73.3 mmol/kg or more, more preferably 73.4 mmol/kg or more, more preferably 73.6 mmol/kg or more, more preferably 73.8 mmol/kg or more, more preferably 74.0 mmol/kg or more.
42. The method, use, polymer, polymer blend, polyol composition and/or polymer product, according to any one of the preceding items, preferably wherein the polymer PM1 is a polyamide and/or preferably wherein the polymer blend PB1 and/or the polymer blend PB2 comprise(s) an additive, preferably a colorant; wherein the content of carboxyl end groups in the polymer blend PB2 and/or the polymer product PP1 is/are 100 mmol/kg or less, preferably 90 mmol/kg or less, more preferably 80 mmol/kg or less, more preferably 75 mmol/kg or less, more preferably 74.9 mmol/kg or less, more preferably 74.8 mmol/kg or less, more preferably 74.7 mmol/kg or less, more preferably 74.6 mmol/kg or less, more preferably 74.5 mmol/kg or less, more preferably 74.4 mmol/kg or less, more preferably 74.3 mmol/kg or less, more preferably 74.2 mmol/kg or less, more preferably 74.1 mmol/kg or less, more preferably 74.0 mmol/kg or less, more preferably 70 mmol/kg or less, more preferably 50 mmol/kg or less, more preferably 25 mmol/kg or less.
43. The method, use, polymer, polymer blend, polyol composition and/or polymer product, according to any one of the preceding items, preferably wherein the polymer PM1 is a polyamide and/or preferably wherein the polymer blend PB1 and/or the polymer blend PB2 comprise(s) an additive, preferably a colorant; wherein the ratio of the content of carboxyl end groups [mmol/kg] to the content of amino end groups [mmol/kg] of the polymer blend PB2 and/or the polymer product PP1 is/are 0.1 or more, preferably 1 or more, more preferably 2 or more, more preferably 3 or more, more preferably 4 or more, more preferably 5 or more, more preferably 6 or more, more preferably 7 or more, more preferably 8.0 or more, more preferably 8.2 or more, more preferably 8.5 or more, more preferably 9.0 or more, more preferably 9.8 or more, more preferably 10.0 or more.
44. The method, use, polymer, polymer blend, polyol composition and/or polymer product, according to any one of the preceding items, preferably wherein the polymer PM1 is a polyamide and/or preferably wherein the polymer blend PB1 and/or the polymer blend PB2 comprise(s) an additive, preferably a colorant; wherein the ratio of the content of carboxyl end groups [mmol/kg] to the content of amino end groups [mmol/kg] of the polymer blend PB2 is 100 or less, preferably 50 or less, more preferably 25 or less, more preferably 20 or less, more preferably 15 or less, more preferably 11 or less, more preferably 10.0 or less, more preferably 9.8 or less, more preferably 9.5 or less, more preferably 9.3 or less, more preferably 8.1 or less.
45. The method, use, polymer, polymer blend, polyol composition and/or polymer product, according to any one of the preceding items, wherein the content of extractables of the polymer blend PB1 and/or polymer blend PB2 and/or the polymer product PP1 is/are 0 weight-% or more, preferably 0.1 weight-% or more, more preferably 0.1 weight-% or more, more preferably 0.2 weight-% or more, more preferably 0.3 weight-% or more, more preferably 0.5 weight-% or more, more preferably 0.8 weight-% or more, more preferably 1.0 weight-% or more, more preferably 1.2 weight-% or more, more preferably 1.4 weight-% or more, more preferably 1.6 weight-% or more, more preferably 1.8 weight-% or more, more preferably 2.0 weight-% or more, more preferably 2.2 weight-% or more, more preferably 2.5 weight-% or more, more preferably 2.8 weight-% or more, more preferably 3.0 weight-% or more.
46. The method, use, polymer, polymer blend, polyol composition and/or polymer product, according to any one of the preceding items, wherein the content of extractables of the polymer blend PB1 and/or polymer blend PB2 and/or the polymer product PP1 is/are 5 weight-% or less, preferably 4 weight-% or less, more preferably 3.5 weight-% or less, more preferably 3.2 weight-% or less, more preferably 3.0 weight-% or less, more preferably 2.5 weight-% or less, more preferably 2.0 weight-% or less, more preferably 1.8 weight-% or less, more preferably 1.3 weight-% or less, more preferably 1.0 weight-% or less, more preferably 0.8 weight-% or less, more preferably 0.6 weight-% or less.
47. The method, use, polymer, polymer blend, polyol composition and/or polymer product, according to any one of the preceding items, wherein the relative viscosity of the polymer blend PB1 and/or polymer blend PB2 and/or the polymer product PP1 is/are 2.00 or more, preferably 2.10 or more, more preferably 2.20 or more, more preferably 2.20 or more, more preferably 2.21 or more, more preferably 2.22 or more, more preferably 2.274 or more, more preferably 2.275 or more, more preferably 2.276 or more, more preferably 2.30 or more, more preferably 2.40 or more.
48. The method, use, polymer, polymer blend, polyol composition and/or polymer product, according to any one of the preceding items, wherein the relative viscosity the polymer blend PB1 and/or polymer blend PB2 and/or the polymer product PP1 is/are 4.00 or less, preferably 3.50 or less, more preferably 3.00 or less, more preferably 2.50 or less, more preferably 2.45 or less, more preferably 2.40 or less, more preferably 2.30 or less, more preferably 2.28 or less, more preferably 2.27 or less.
49. The method, use, polymer, polymer blend, polyol composition and/or polymer product, according to any one of the preceding items, wherein the polymer blend PB1 is a textile, a yarn, a monofilament, a foam, and/or an injection-moulded article, an extruded film; and mixtures thereof, preferably a textile.
50. The method, use, polymer, polymer blend, polyol composition and/or polymer product, according to any one of the preceding items, wherein the polymer blend PB1 and/or polymer blend PB2 and/or the polymer product PP1 is/are solid at 25° C., preferably 50° C., more preferably 75° C.
51. The method, use, polymer, polymer blend, polyol composition and/or polymer product, according to any one of the preceding items, wherein the polymer blend PB1 and/or polymer blend PB2 and/or the polymer product PP1 comprise(s), preferably consist(s) of, the polymer PM1 and the polymer PM2 and one or more additive(s) A1.
52. The method, use, polymer, polymer blend, polyol composition and/or polymer product, according to any one of the preceding items, wherein the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 91 weight-% or more, more preferably 95 weight-% or more, more preferably 96 weight-% or more, polymer PM1 with regard to the solvent S2, the polymer blend PB1, the polymer blend PB2, and the polymer product PP1, respectively.
53. The method, use, polymer, polymer blend, polyol composition and/or polymer product, according to any one of the preceding items, wherein the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, polymer PM1 with regard to the solvent S2, the polymer blend PB1, the polymer blend PB2, and the polymer product PP1, respectively.
54. The method, use, polymer, polymer blend, polyol composition and/or polymer product, according to any one of the preceding items, wherein the solvent S2, the polymer blend PB1, the polymer blend PB2 and/or the polymer product PP1 comprise(s) 0.01 weight-% or more, preferably 0.1 weight-% or more, more preferably 1 weight-% or more, more preferably 3 weight-% or more, more preferably 5 weight-% or more, more preferably 10 weight-% or more, more preferably 25 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 95 weight-% or more, polymer PM2 with regard to the solvent S2, the polymer blend PB1, the polymer blend PB2, and the polymer product PP1, respectively.
55. The method, use, polymer, polymer blend, polyol composition and/or polymer product, according to any one of the preceding items, wherein the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, more preferably 3 weight-% or less, more preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM2 with regard to the solvent S2, the polymer blend PB1, the polymer blend PB2, and the polymer product PP1, respectively.
56. The method, use, polymer, polymer blend, polyol composition and/or polymer product, according to any one of the preceding items, wherein the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 95 weight-% or more, polymer PM1 and polymer PM2 with regard to the solvent S2, the polymer blend PB1, the polymer blend PB2, and the polymer product PP1, respectively.
57. The method, use, polymer, polymer blend, polyol composition and/or polymer product, according to any one of the preceding items, wherein the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, more preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM1 and polymer PM2 with regard to the solvent S2, the polymer blend PB1, the polymer blend PB2, and the polymer product PP1, respectively.
58. The method, use, polymer, polymer blend, polyol composition and/or polymer product, according to any one of the preceding items, wherein the polymer PM1 and/or the polymer PM3 is/are obtainable by polymerizing the solvent SO1, optionally together with the monomer(s) MO1, MO2, MO3 and/or MO4.
59. The method, use, polymer, polymer blend, polyol composition and/or polymer product, according to any one of the preceding items, wherein the polymer PM1 and/or the polymer PM3 is/are a polyamide, preferably selected from PA 4, PA 5, PA 6, PA 7, PA 8, PA 9, PA 10, PA 11, PA 12, PA 45, PA 4.6, PA 5.5, PA 5.6, PA 6.6, PA 6/6.6, PA 6.9, PA 5.10, PA 6.10, PA 6.12, PA 6/6.36, PA 6.6/6.36, PA 9.6, PA 9.9, PA 9.10, PA 9.12, PA 12.12, PA 6.T, PA 8.T, PA 9.T, PA 10.T, PA 12.T, PA 6.I, PA 8.I, PA 9.I, PA 10.I, PA 12.I, PA 6.T/6, PA 6.T/10, PA 6.T/12, PA 6.T/6.I, PA 6.T/8.T, PA 6.T/9.T, PA 6.T/10.T, PA 6.T/12.T, PA 12.T/6.T, PA 6.T/6.I/6, PA 6.T/6.I/12, PA 6.T/6.I/6.10, PA 6.T/6.I/6.12, PA 6.T/6.6, PA 6.T/6.10, PA 6.T/6.12, PA 10.T/6, PA 10.T/11, PA 10.T/12, PA 8.T/6.T, PA 8.T/66, PA 8.T/8.I, PA 8.T/8.6, PA 8.T/6.I, PA 10.T/6.T, PA 10.T/6.6, PA 10.T/10.I, PA 10.T/10.I/6.T, PA 10.T/6.I, PA 4.T/4.I/4.6, PA 4.T/4.I/6.6, PA 5.T/5.I, PA 5.T/5.1/5.6, PA 5.T/5.I/6.6, PA 6.T/6.I/6.6, PA MXDA.6, PA IPDA.I, PA IPDA.T, PA MACM.I, PA MACM.T, PA PACM.I, PA PACM.T, PA MXDA.I, PA MXDA.T, PA 6.T/IPDA.T, PA 6.T/MACM.T, PA 6.T/PACM.T, PA 6.T/MXDA.T, PA 6.T/6.I/8.T/8.I, PA 6.T/6.I/10.T/10.I, PA 6.T/6.I/IPDA.T/IPDA.I, PA 6.T/6.I/MXDA.T/MXDA.I, PA 6.T/6.I/MACM.T/MACM.I, PA 6.T/6.I/PACM.T/PACM.I, PA 6.T/10.T/IPDA.T, PA 6.T/12.T/IPDA.T, PA 6.T/10.T/PACM.T, PA 6.T/12.T/PACM.T, PA 10.T/IPDA.T, PA 12.T/IPDA.T; and copolymers and mixtures thereof; preferably PA 6 and PA 6.6; and copolymers and mixtures thereof, more preferably wherein the polymer PM1 and/or the polymer PM3 is/are PA 6 and/or PA 6.6, more preferably wherein the polymer PM1 and/or the polymer PM3 is/are PA 6.
60. The method, use, polymer, polymer blend, polyol composition and/or polymer product, according to any one of the preceding items, wherein the polymer PM1 is not polyurea, preferably is not polyurethane and polyurea.
61. The method, use, polymer, polymer blend, polyol composition and/or polymer product, according to any one of the preceding items, wherein the polymer PM1 and/or the polymer PM3 is/are a polyethylene terephthalate (PET).
62. The method, use, polymer, polymer blend, polyol composition and/or polymer product, according to any one of the preceding items, wherein the polymer PM1 and/or the polymer PM3 is/are a polyester and/or a cellulose based polymer.
63. The method, use, polymer, polymer blend, polyol composition and/or polymer product, according to any one of the preceding items, wherein the solubility of the polymer PM1 in the solvent S1 is 4 g/L or less, preferably 3 g/L or less, more preferably 2 g/L or less, more preferably 1 g/L or less, more preferably 0.1 g/L or less.
64. The method, use, polymer blend PB2 and/or polymer product PP1, according to any one of the preceding items, wherein the polymer PM2 and/or the polymer PM3 and/or the polymer PM4 is/are polyurethane and/or polyurea, preferably a thermoset and/or thermoplastic polyurethane or polyurea; or mixtures thereof, more preferably a thermoplastic polyurethane or polyurea; or mixtures thereof, more preferably a thermoplastic polyurethane based on an aromatic isocyanate and/or a thermoplastic polyurethane based on aliphatic isocyanate.
65. The method, use, polymer, polymer blend, polyol composition and/or polymer product, according to any one of the preceding items, wherein the polymer PM2 and/or the polymer PM3 and/or the polymer PM4 is/are a polyurethane and/or a polyurea, preferably a polyurea obtainable by a composition A and a composition B,
   wherein the composition A comprises a compound comprising at least two, preferably two or three, isocyanate groups, preferably wherein the composition A comprises a compound selected from aliphatic, cycloaliphatic and aromatic compounds comprising at least two, preferably two or three, isocyanate groups, more preferably wherein the compound is selected from 2,2′-, 2,4′- and 4,4′-methylene diphenyl diisocyanate (MDI) and homologs thereof, isophorone diisocyanate (IPDI), 2,4- and 2,6-toluene diisocyanate (TDI), tetramethylene diisocyanate, hexamethylene diisocyanate (HDI), naphthylene diisocyanate (NDI); and oligomers and mixtures thereof; and
   wherein composition B comprises a compound comprising at least two alcohol groups, preferably wherein the compound B is selected from an aliphatic, cycloaliphatic and aromatic compound comprising at least two alcohol groups, more preferably wherein the composition B comprises a compound selected from polyol, polyetherpolyole, polyesterpolyole, and mixtures thereof, more preferably wherein the composition B comprises a compound having a molecular weight of 400 g/mol to 15000 g/mol and is selected from polyol, polyetherpolyole, polyesterpolyole, and mixtures thereof, and/or wherein composition B comprises a compound comprising at least two functional groups reactive to isocyanate groups, preferably at least two functional groups selected from alcohol, amine; and mixtures thereof, and/or
   wherein composition B comprises water, ethylene glycol, diethylene glycol, triethylene glycol, tetraethylene glycol, propylene glycol, dipropylene glycol, tripropylene glycol, 1,3-propanediol, 1,3-butanediol, 1,4-butanediol, neopentyl glycol, 1,6-hexanediol, 1,4-cyclohexanedimethanol, hydroquinone bis(2-hydroxyethyl)ether, ethanolamine, diethanolamine, methyldiethanolamine, phenyldiethanolamine, glycerol, trimethylolpropane, 1,2,6-hexanetriol, triethanolamine, pentaerythritol, N,N,N′,N′-tetrakis(2-hydroxypropyl)ethylenediamine, diethyltoluenediamine, dimethylthiotoluenediamine; and mixtures thereof; optionally copolymerized with an epoxide compound, preferably ethylene oxide and/or propylene oxide.
66. The method, use, polymer, polymer blend, polyol composition and/or polymer product, according to any one of the preceding items, wherein the solubility of the polymer PM2 and/or the polymer PM4 in the solvent S1 is 3 g/L or more, preferably 4 g/L or more, more preferably 5 g/L or more, more preferably 10 g/L or more, more preferably 15 g/L or more, more preferably 25 g/L or more, more preferably 50 g/L or more, more preferably 100 g/L or more, more preferably 200 g/L or more.
67. The method, use, polymer, polymer blend, polyol composition and/or polymer product, according to any one of the preceding items, wherein the polymer PM2 and/or the polymer PM4 is not a polyamide.
68. The method, use, polymer, polymer blend, polyol composition and/or polymer product, according to any one of the preceding items, wherein the polymer PM2 and the polymer PM3 are the same and/or wherein the polymer PM2 and the polymer PM4 are the same and/or wherein the polymer PM3 and the polymer PM4 are the same, preferably wherein the polymer PM2, the polymer PM3 and the polymer PM4 are the same.
69. The method, use, polymer, polymer blend, polyol composition and/or polymer product, according to any one of the preceding items, wherein the polymer PM3 is a polymer selected from polyamide (PA), polyurethane (PU), low-density polyethylene (LDPE), high-density polyethylene (HDPE), polyethylene (PE), polypropylene (PP), polyvinyl chloride (PVC), polystyrene (PS), polytetrafluoroethylene (Teflon), thermoplastic polyurethanes (TPU), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO); and copolymers and mixtures thereof.
70. The method, use, polymer, polymer blend, polyol composition and/or polymer product, according to any one of the preceding items, wherein the polymer PM1 and the polymer PM3 are the same.
71. The method, use, polymer, polymer blend, polyol composition and/or polymer product, according to any one of the preceding items, wherein the polymer blend PB1, preferably the polymer blend PB1 and/or polymer blend PB2, more preferably the polymer blend PB1 and/or the polymer blend PB2 and/or the solvent blend SO2, comprises one or more additive(s) A1.
72. The method, use, polymer, polymer blend, polyol composition and/or polymer product, according to any one of the preceding items, wherein the additive(s) A1 is/are selected from fiber(s), antioxidating agent(s), stabilizer(s), lubricant(s), mineral(s), colorant(s), pigments, soot, talc, and mixtures thereof.
73. The method, use, polymer, polymer blend, polyol composition and/or polymer product, according to any one of the preceding items, wherein the additive(s) A1 is/are compliant with at least one of the Gulf Cooperation Council Standardization Organization GSO 2231/2012, and/or GSO 839/1997, and/or GSO 1863/2013 standard; or is/are Halal certified, and/or Kosher certified, and/or HACCP certified.
74. The method, use, polymer, polymer blend, polyol composition and/or polymer product, according to any one of the preceding items, wherein the solvent S1 comprises a solvent SO2, wherein the solvent SO1 and the solvent SO2 are not the same.
75. The method, use, polymer, polymer blend, polyol composition and/or polymer product, according to any one of the preceding items, wherein the solvent S1 does not contain dimethylformamide DMF, preferably dimethylformamide DMF, dimethylacetamide DMAc and/or N-Methyl-2-pyrrolidone NMP.
76. The method, use, polymer, polymer blend, polyol composition and/or polymer product, according to any one of the preceding items, wherein the content of the solvent SO1 and/or, preferably and, the solvent SO2 in the solvent S1 is 20 weight-% or more, preferably 30 weight-% or more, more preferably 50 weight-% or more, more preferably 75 weight-% or more, more preferably 80 weight-% or more, more preferably 85 weight-% or more, more preferably 90 weight-% or more, more preferably 95 weight-% or more, more preferably 98 weight-% or more, more preferably wherein the solvent blend consists of the solvent SO1 and the solvent SO2, preferably the solvent SO1.
77. The method, use, polymer, polymer blend, polyol composition and/or polymer product, according to any one of the preceding items, wherein the solvent SO1 and the solvent SO2 are miscible, preferably at 25° C. and/or at the temperature used in the contacting step.
78. The method, use, polymer, polymer blend, polyol composition and/or polymer product, according to any one of the preceding items, wherein the solvent S1 is a homogeneous solvent blend, preferably at 25° C. and/or at the temperature used in the contacting step.
79. The method, use, polymer, polymer blend, polyol composition and/or polymer product, according to any one of the preceding items, wherein in the following equation:

$$\frac{solvent SO 1 [ kg ]}{solvent SO 1 [ kg ] + solvent SO 2 [ kg ]} \geq x 1$$

x1 is 0.01, preferably 0.1, more preferably 0.2, more preferably 0.3, more preferably 0.4, more preferably 0.4, more preferably 0.5, more preferably 0.6, more preferably 0.7, more preferably 0.8, more preferably 0.9, more preferably 0.95, more preferably 0.97.
80. The method, use, polymer, polymer blend, polyol composition and/or polymer product, according to any one of the preceding items, wherein in the following equation:

$$\frac{solvent SO 1 [ kg ]}{solvent SO 1 [ kg ] + solvent SO 2 [ kg ]} \leq x 2$$

x2 is 0.99, preferably 0.97, more preferably 0.95, more preferably 0.9, more preferably 0.8, more preferably 0.7, more preferably 0.6, more preferably 0.5, more preferably 0.4, more preferably 0.3, more preferably 0.2, more preferably 0.1, more preferably 0.05.
81. The method, use, polymer, polymer blend, polyol composition and/or polymer product, according to any one of the preceding items, wherein in the following equation:

$$\frac{solvent SO 2 [ kg ]}{solvent SO 1 [ kg ] + solvent SO 2 [ kg ]} \geq y 1$$

y1 is 0.01, preferably 0.05, more preferably 0.07, more preferably 0.10, more preferably 0.15, more preferably 0.2, more preferably 0.3, more preferably 0.4, more preferably 0.5, more preferably 0.6, more preferably 0.7, more preferably 0.8, more preferably 0.9, more preferably 0.95, more preferably 0.97.
82. The method, use, polymer, polymer blend, polyol composition and/or polymer product, according to any one of the preceding items, wherein in the following equation:

$$\frac{solvent SO 2 [ kg ]}{solvent SO 1 [ kg ] + solvent SO 2 [ kg ]} \leq y 2$$

y2 is 0.99, preferably 0.97, more preferably 0.95, more preferably 0.9, more preferably 0.8, more preferably 0.7, more preferably 0.6, more preferably 0.5, more preferably 0.4, more preferably 0.3, more preferably 0.2, more preferably 0.1, more preferably 0.05.
83. The method, use, polymer, polymer blend, polyol composition and/or polymer product, according to any one of the preceding items, wherein the ratio [weight/weight] of the solvent SO1 to the solvent SO2 is 0.01 or more and 100 or less, preferably 0.03 or more and 30 or less, more preferably 0.05 or more and 5 or less, more preferably 0.10 or more and 1 or less, more preferably 0.15 or more and 0.50 or less.
84. The method, use, polymer, polymer blend, polyol composition and/or polymer product, according to any one of the preceding items, wherein the solvent SO1 and/or, preferably and, the solvent SO2 is/are (a) protic solvent(s).
85. The method, use, polymer, polymer blend, polyol composition and/or polymer product, according to any one of the preceding items, wherein the melting point of the solvent SO1 is higher than the melting point of the solvent SO2.
86. The method, use, polymer, polymer blend, polyol composition and/or polymer product, according to any one of the preceding items, wherein in the following equation:

$$[ MP ] A - [ MP ] B \geq z 1$$

wherein [MP]A is the melting point of the solvent SO1 in ° C., and
wherein [MP]B is the melting point of the solvent SO2 in ° C.,
z1 is 5° C., preferably 25° C., more preferably 50° C., more preferably 75° C., more preferably 100° C., more preferably 125° C., more preferably 150° C., more preferably 160° C.
87. The method, use, polymer, polymer blend, polyol composition and/or polymer product, according to any one of the preceding items, wherein the melting point of the solvent S1 is 0° C. or more, preferably 25° C. or more, more preferably 50° C. or more, more preferably 55° C. or more, more preferably 60° C. or more, more preferably 65° C. or more, more preferably 70° C. or more.
88. The method, use, polymer, polymer blend, polyol composition and/or polymer product, according to any one of the preceding items, wherein the melting point of the solvent S1 is 250° C. or less, preferably 200° C. or less, more preferably 150° C. or less, more preferably 125° C. or less, more preferably 100° C. or less, more preferably 90° C. or less, more preferably 80° C. or less, more preferably 80° C. or less, more preferably 70° C. or less, more preferably 60° C. or less, more preferably 50° C. or less, more preferably 30° C. or less, more preferably 25° C. or less, more preferably 20° C. or less, more preferably 15° C. or less.
89. The method, use, polymer, polymer blend, polyol composition and/or polymer product, according to any one of the preceding items, wherein the solvent SO1 can be polymerized, preferably optionally together with monomer(s) MO1, and/or, MO2, and/or MO3, to obtain the polymer PM1.
90. The method, use, polymer, polymer blend, polyol composition and/or polymer product, according to any one of the preceding items, wherein the solvent SO1 comprises, preferably consists of, the elements C, O and H, preferably C, O, N and H.
91. The method, use, polymer, polymer blend, polyol composition and/or polymer product, according to any one of the preceding items, wherein the solvent SO1 is an amide, preferably a lactam, preferably 2-pyrrolidone, 2-piperidone, caprolactam and/or laurolactam, more preferably caprolactam and/or laurolactam, more preferably caprolactam, more preferably ε-caprolactam.
92. The method, use, polymer, polymer blend, polyol composition and/or polymer product, according to any one of the preceding items, wherein the solvent SO2 comprises the elements O and H, preferably C, O and H.
93. The method, use, polymer, polymer blend, polyol composition and/or polymer product, according to any one of the preceding items, wherein the solvent SO2 comprises an —OH group, preferably is water and/or alcohol, preferably methanol, ethanol, propanol and/or water, more preferably water.
94. The method, use, polymer, polymer blend, polyol composition and/or polymer product, according to any one of the preceding items, wherein the solvent SO2 is selected from the group consisting of water and organic solvents having a octanol-water partition coefficient log K_{OW} in the range of from −1.6 to +1.6, preferably selected from the group consisting of water, C5 to C12 alkane, aliphatic C1 to C10 alcohol, C3 to C10 ketone, C2 to C10 cyclic ketone, HO—[C1 to C10 alkyl-O-]ₙ-H, with n being an integer in the range of from 2 to 1000, C1 to C10 alkyl-O—C3 to C10 alkyl ether, C3 to C10 cyclic ether, optionally substituted with one or more C1 to C6 alkyl group(s), C6 to C10 aromatic hydrocarbon, optionally substituted with one or more C1 to C6 alkyl group(s), C2 to C10 aliphatic ester, C8 to C11 aromatic ester, C5 to C10 cyclic carboxylic ester (lactone), C3 to C12 amide, preferably R1R2N—C(═O)—R3, wherein R1, R2 are independently a C1 to C4 alkyl group and R3 is selected from the group consisting of C1 to C9 alkyl group, C1 to C10 ester group and C1 to C6 ether group, C3 to C6 lactam, optionally substituted with one or more substituent selected from C1 to C6 alkyl group, C1 to C6 ester group and C1 to C6 ether group, and C5 imidazolidine, optionally substituted with one or more C1 to C6 alkyl group(s), C5 to C7 imidazolidone, optionally substituted with one or more C1 to C6 alkyl group(s).
95. The method, use, polymer, polymer blend, polyol composition and/or polymer product, according to any one of the preceding items, wherein the boiling point of the solvent SO2 is 0° C. to 150° C., preferably 10° C. to 120° C., more preferably 20° C. to 110° C., more preferably 30° C. to 100° C., more preferably 50° C. to 90° C., more preferably 60° C. to 80° C.
96. The method, use, polymer, polymer blend, polyol composition and/or polymer product, according to any one of the preceding items, wherein the solvent S2 comprises the same solvents as the solvent S1 and/or the solvent S2 comprises solvent SO1, preferably and solvent SO2.
97. The method, use, polymer, polymer blend, polyol composition and/or polymer product, according to any one of the preceding items, wherein the solvent S2 comprises one or more, preferably two, solvents selected from a list consisting of lactam, preferably caprolactam, methanol, ethanol, propanol, isopropanol, acetonitrile, ethyl acetate, acetone, and water; preferably lactam, preferably caprolactam, and water and/or methanol; more preferably lactam, preferably caprolactam, and water.
98. The method, use, polymer, polymer blend, polyol composition and/or polymer product, according to any one of the preceding items, wherein the polymer product PP1, PP2, PP3 and/or PP4 is/are a textile, a yarn, a monofilament, a foam, a granulate, a foil, an injection-moulded article, and/or an extruded film; and mixtures thereof, preferably a textile.
99. The method, use, polymer, polymer blend, polyol composition and/or polymer product, according to any one of the preceding items, wherein the polymer product PP1, PP2, PP3 and/or PP4 comprise(s) at least 1% of the polymer PM1 and/or the polymer PM3, preferably obtained by or obtainable by the method according to any one of the preceding items.
100. The method, use, polymer, polymer blend, polyol composition and/or polymer product, according to any one of the preceding items, wherein the polymer product PP1, PP2, PP3 and/or PP4 comprise(s) the polymer PM1.
101. The method, use, polymer, polymer blend, polyol composition and/or polymer product, according to any one of the preceding items, wherein the polymer product PP1, PP2, PP3 and/or PP4 comprise(s) the polymer PM2.
102. The method, use, polymer, polymer blend, polyol composition and/or polymer product, according to any one of the preceding items, wherein the polymer product PP1, PP2, PP3 and/or PP4 comprise(s) the polymer PM3.
103. The method, use, polymer, polymer blend, polyol composition and/or polymer product, according to any one of the preceding items, wherein the polymer product PP1, PP2, PP3 and/or PP4 comprise(s) the polymer PM4.
104. The method, use, polymer, polymer blend, polyol composition and/or polymer product, according to any one of the preceding items, wherein the polymer blend PB2 and/or the polymer product PP1, PP2, PP3 and/or PP4 is/are amorphous.
105. The method, use, polymer, polymer blend, polyol composition and/or polymer product, according to any one of the preceding items, wherein the polymer blend PB2 and/or the polymer product PP1, PP2, PP3 and/or PP4 is/are semicrystalline.
106. The method, use, polymer, polymer blend, polyol composition and/or polymer product, according to any one of the preceding items, wherein the recycling content in the polymer product PP1, PP2, PP3 and/or PP4 is/are 5 weight-% or more, preferably 10 weight-% or more, more preferably 20 weight-% or more, more preferably 25 weight-% or more, more preferably 30 weight-% or more, more preferably 35 weight-% or more, more preferably 50 weight-% or more, more preferably 75 weight-% or more, more preferably 80 weight-% or more, more preferably about 100 weight-%.
107. The method, use, polymer, polymer blend, polyol composition and/or polymer product, according to any one of the preceding items, wherein the monomer(s) MO1 and/or MO3 is/are a lactam, preferably caprolactam, more preferably ε-caprolactam.
108. The method, use, polymer, polymer blend, polyol composition and/or polymer product, according to any one of the preceding items, wherein the monomer MO1 and/or the monomer MO2 and/or the monomer MO3 and/or the monomer MO4 is a monomer which can be polymerized, optionally together with a further monomer, to obtain a polymer selected from polyamide (PA), polyurethane (PU), low-density polyethylene (LDPE), high-density polyethylene (HDPE), polyethylene (PE), polypropylene (PP), polyvinyl chloride (PVC), polystyrene (PS), polytetrafluoroethylene (Teflon), thermoplastic polyurethanes (TPU), poly(methyl acrylate) (PMA), poly(methyl methacrylate) (PMMA), polybutadiene (BR, PBD), poly(cis-1,4-isoprene), poly(trans-1,4-isoprene), polyoxymethylene (POM), polyethylene terephthalate (PET), polyhydroxyalkanoate (PHA), poly-3-hydroxybutyrate (P3HB), poly-4-hydroxybutyrate (P4HB), polyhydroxyvalerate (PHV), polyhydroxyhexanoate (PHH), polyhydroxyoctanoate (PHO); and copolymers and mixtures thereof.
109. The method, use, polymer, polymer blend, polyol composition and/or polymer product, according to any one of the preceding items,
   wherein the polymer blend PB2 and/or the polymer product PP1, PP2, PP3 and/or PP4 exhibits improved workability, and/or
   wherein the polymer blend PB2 and/or the polymer product PP1, PP2, PP3 and/or PP4 exhibits improved skin sensitivity; and/or
   wherein the polymer blend PB2 and/or the polymer product PP1, PP2, PP3 and/or PP4 exhibits improved carbon footprint.
110. The method, use, polymer, polymer blend, polyol composition and/or polymer product, according to any one of the preceding items,
   wherein the solvent S1 is a solvent blend SB1.
111. The method, use, polymer, polymer blend, polyol composition and/or polymer product, according to any one of the preceding items,
   wherein the solvent S1 consists of a/the solvent SO1.
112. The method, use, polymer, polymer blend, polyol composition and/or polymer product, according to any one of the preceding items, wherein the solvent S1 comprises, preferably consists of, a/the solvent SO1 and a/the solvent SO2.
113. The method, use, polymer, polymer blend, polyol composition and/or polymer product, according to any one of the preceding items, wherein the solvent S2 comprises, preferably consists of, solvent SO1, preferably solvent SO1, polymer PM2 and one or more additive(s), more preferably solvent SO1, solvent SO2, polymer PM2 and one or more additive(s), more preferably solvent SO1, solvent SO2, polymer PM1, polymer PM2 and one or more additive(s).
114. The method, use, polymer, polymer blend, polyol composition and/or polymer product, according to any one of the preceding items, wherein the solvent S2 is a solvent blend SB2.
115. The method, use, polymer, polymer blend, polyol composition and/or polymer product, according to any one of the preceding items, wherein the solvent S1 and/or, preferably and, the solvent S2 do(es) not comprise dimethylformamide DMF, dimethylacetamide DMAc, 1-methylpyrrolidin-2-one NMP, 2-pyrrolidone, 2-piperidone, 2,2′-diaminodiethylamine (DETA), diisopropylamine, pyridine, pentylamine, N,N-diethylethanamine, diethylengylcol, tetrahydrofuran THF, hexamethylphosphoramide HMPA, acetonitrile, dimethylsulfoxide DMSO, and/or, preferably and, 1,4-butanediol.
116. The method, use, polymer, polymer blend, polyol composition and/or polymer product, according to any one of the preceding items, wherein the polymer PM2 and/or the polymer PM3 and/or the polymer PM4 comprises, preferably consists of, polyurethane and/or polyurea, more preferably polyurea, more preferably a copolymer comprising polyurea, more preferably polyether-polyurea copolymer.
117. The method, use, polymer, polymer blend, polyol composition and/or polymer product, according to any one of the preceding items, wherein the solvent SO1 is a monoalcohol, preferably methanol and/or ethanol, more preferably methanol.
118. The method, use, polymer, polymer blend, polyol composition and/or polymer product, according to any one of the preceding items, wherein the solvents in solvent S1 and the solvents in solvent S2 are the same.
119. The method, use, polymer, polymer blend, polyol composition and/or polymer product, according to any one of the preceding items, wherein the shape of the polymer product PP1 and/or the polymer product PP2 and/or the polymer product PP3 and/or the polymer product PP4 is/are a foil, granulate, powder, laminate, foam, molded article, pipe.
120. The method, use, polymer, polymer blend, polyol composition and/or polymer product, according to any one of the preceding items, wherein the polymer product PP1 and/or the polymer product PP2 and/or the polymer product PP3 and/or the polymer product PP4 is/are or is/are a part of:
   a part of a car; preferably cylinder head cover, engine cover, housing for charge air cooler, charge air cooler flap, intake pipe, intake manifold, connector, gear wheel, fan wheel, cooling water box, housing, housing part for heat exchanger, coolant cooler, charge air cooler, thermostat, water pump, radiator, fastening part, part of battery system for electromobility, dashboard, steering column switch, seat, headrest, center console, transmission component, door module, A, B, C or D pillar cover, spoiler, door handle, exterior mirror, windscreen wiper, windscreen wiper protection housing, decorative grill, cover strip, roof rail, window frame, sunroof frame, antenna panel, headlight and taillight, engine cover, cylinder head cover, intake manifold, airbag, cushion, or coating;
   a cloth; preferably shirt, trousers, pullover, boot, shoe, shoe sole, tight or jacket;
   an electrical part; preferably electrical or electronic passive or active component, circuit breaker, circuit board, printed circuit board, terminal block, housing component, foil, line, switch, switch gear, plug, socket, distributor, relay, resistor, capacitor, inductor, bobbin, lamp, diode, LED, transistor, connector, regulator, integrated circuit (IC), processor, controller, memory, sensor, microswitch, microbutton, semiconductor, reflector housing for light-emitting diodes (LED), fastener for electrical or electronic component, spacer, bolt, strip, slide-in guide, screw, nut, film hinge, snap hook (snap-in), or spring tongue;
   a consumer, agricultural product or pharmaceutical product; preferably tennis string, climbing rope, bristle, brush, artificial grass, 3D printing filament, grass trimmer, zipper, hook and loop fastener, paper machine clothing, extrusion coating, fishing line, fishing net, offshore line and rope, vial, syringe, ampoule, bottle, sliding element, spindle nut, chain conveyor, plain bearing, roller, wheel, gear, roller, ring gear, screw and spring dampers, hose, pipeline, cable sheathing, socket, switch, cable tie, fan wheel, carpet, box or bottle for cosmetics, mattress, cushion, insulation, detergent, dishwasher tabs or powder, shampoo, body wash, shower gel, soap, fertilizer, fungicide, or pesticide;
   a packaging for the food industry; preferably mono- or multi-layer blown film, cast film (mono- or multi-layer), biaxially stretched film, or laminating film; or
   a part of a construction; preferably a rotor blade, insulating material, frame, housing, wall, coating, or separating wall.
121. The method, use, polymer, polymer blend, polyol composition and/or polymer product, according to any one of the preceding items, wherein the content of the solvent SO1 in the solvent S1 and/or, preferably and, the solvent S2 is 20 weight-% or more, preferably 30 weight-% or more, more preferably 50 weight-% or more, more preferably 75 weight-% or more, more preferably 80 weight-% or more, more preferably 85 weight-% or more, more preferably 90 weight-% or more, more preferably 95 weight-% or more, more preferably 98 weight-% or more, more preferably wherein the solvent blend consists of the solvent SO1 and the solvent SO2, preferably the solvent SO1.
122. The method, use, polymer, polymer blend, polyol composition and/or polymer product, according to any one of the preceding items, wherein the content of the solvent SO1 in the solvent S1 and/or, preferably and, the solvent S2 is 100 weight-% or less, preferably 99 weight-% or less, more preferably 95 weight-% or less, more preferably 90 weight-% or less, more preferably 85 weight-% or less, more preferably 80 weight-% or less, more preferably 75 weight-% or less, more preferably 70 weight-% or less, more preferably 50 weight-% or less.
123. The method, use, polymer, polymer blend, polyol composition and/or polymer product, according to any one of the preceding items, wherein the content of the solvent SO2 in the solvent S1 and/or, preferably and, the solvent S2 is 1 weight-% or more, preferably 2 weight-% or more, more preferably 5 weight-% or more, more preferably 8 weight-% or more, more preferably 10 weight-% or more, more preferably 15 weight-% or more, more preferably 20 weight-% or more, more preferably 30 weight-% or more, more preferably 40 weight-% or more, more preferably 50 weight-% or more.
124. The method, use, polymer, polymer blend, polyol composition and/or polymer product, according to any one of the preceding items, wherein the content of the solvent SO2 in the solvent S1 and/or, preferably and, the solvent S2 is 100 weight-% or less, preferably 50 weight-% or less, more preferably 30 weight-% or less, more preferably 25 weight-% or less, more preferably 22 weight-% or less, more preferably 18 weight-% or less, more preferably 15 weight-% or less, more preferably 12 weight-% or less, more preferably 10 weight-% or less.
125. The method, use, polymer, polymer blend, polyol composition and/or polymer product, according to any one of the preceding items, wherein in the solvent S1 and/or, preferably and, the solvent S2 a ratio (weight/weight) of the content of the solvent SO2 to the content of the solvent SO1 is 0.01 to 0.50, preferably 0.05 to 0.40, more preferably 0.10 to 0.30, more preferably 0.15 to 0.25.
126. The method, use, polymer, polymer blend, polyol composition and/or polymer product, according to any one of the preceding items, wherein the polymer blend PB1 and/or the polymer blend PB2 and/or the polymer product comprises, preferably consist of, polymer PM1, polymer PM2 and one or more additive(s).
127. The method, use, polymer, polymer blend, polyol composition and/or polymer product, according to any one of the preceding items, wherein the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 91 weight-% or more, more preferably 95 weight-% or more, more preferably 96 weight-% or more, polymer PM1 with regard to the solvent S2, the polymer blend PB1, the polymer blend PB2 and/or the polymer product PP1.
128. The method, use, polymer, polymer blend, polyol composition and/or polymer product, according to any one of the preceding items, wherein the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, more preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM1 with regard to the solvent S2, the polymer blend PB1, the polymer blend PB2 and/or the polymer product PP1.
129. The method, use, polymer, polymer blend, polyol composition and/or polymer product, according to any one of the preceding items, wherein the solvent S2, the polymer blend PB1, the polymer blend PB2 and/or the polymer product PP1 comprise(s) 0.1 weight-% or more, preferably 1 weight-% or more, more preferably 5 weight-% or more, more preferably 10 weight-% or more, more preferably 20 weight-% or more, more preferably 30 weight-% or more, more preferably 40 weight-% or more, more preferably 50 weight-% or more, more preferably 60 weight-% or more, more preferably 70 weight-% or more, more preferably 80 weight-% or more, more preferably 90 weight-% or more, more preferably 91 weight-% or more, more preferably 95 weight-% or more, more preferably 96 weight-% or more, polymer PM2 with regard to the solvent S2, the polymer blend PB1, the polymer blend PB2 and/or the polymer product PP1.
130. The method, use, polymer, polymer blend, polyol composition and/or polymer product, according to any one of the preceding items, wherein the solvent S2, the polymer blend PB1, the polymer blend PB2 and/or the polymer product PP1 comprise(s) 99.9 weight-% or less, preferably 98 weight-% or less, more preferably 95 weight-% or less, more preferably 90 weight-% or less, more preferably 80 weight-% or less, more preferably 70 weight-% or less, more preferably 60 weight-% or less, more preferably 50 weight-% or less, more preferably 40 weight-% or less, more preferably 30 weight-% or less, more preferably 20 weight-% or less, more preferably 10 weight-% or less, more preferably 5 weight-% or less, more preferably 2 weight-% or less, more preferably 1 weight-% or less, more preferably 0.5 weight-% or less, more preferably 0.1 weight-% or less, more preferably 0.01 weight-% or less, more preferably 0.001 weight-% or less, polymer PM2 with regard to the solvent S2, the polymer blend PB1, the polymer blend PB2 and/or the polymer product PP1.

### EXAMPLES

### General Procedure

Polymeric material, i.e. the polymer blend PB1 comprising polyamide, polyurethane and/or polyurea and a colorant, was cut into pieces and placed in a reaction vessel (e.g. flask, tube, reaction vessel). ε-caprolactam (99.7%) was pre-molten at 85° C. respectively caprolactam water mixture (20 weight-% water) or caprolactam methanol mixture (10 weight-% methanol) was prepared and added, wherein the mass-based ratio textile:solvent was 1:10 (weight/weight). The mixture was heated to 85° C. in case of use of caprolactam. Respectively, the mixture was heated to 25° C. or 50° C. when using caprolactam/water or caprolactam/methanol using an oil bath. After 16 h the textiles were separated from the liquid phase by decantation to obtain the extracted textile pieces. Subsequent the textile pieces were washed with water and dried in vacuo at 80° C.

The samples were analyzed before treatment and after the final drying step (polymeric material depleted of elastic fiber). A quantitative ¹H-NMR was measured to determine the polyamide content and IR spectroscopy to show the change of characteristic peaks before and after treatment and in comparison, to known spectra for polyamide and elastic fiber based on polyurethane, polyurea(s) and polyether(s).

### Reference and Examples 1 to 4

Material from tights comprising elastic fiber, i.e. a polyurea, and polyamide 6.6 was treated as described in the General Procedure, wherein type of polymeric material and experimental conditions, as well as results are indicated in Table 1. The samples were analyzed before treatment and after the final drying step, a quantitative ¹H-NMR were measured to determine the polyamide (PA) content before and after the separation and IR spectroscopy was performed to demonstrate the change of peaks before and after separation and in comparison, with known spectra for polyamide.

TABLE 1
Experimental results of separation of
elastic fiber and PA from tights.

| Sample | Method | PA content (q¹H-NMR) |
|---|---|---|
| Reference | Untreated | 83% |
| 1 | Caprolactam (pure), 85° C. | 96% |
| 2 | Caprolactam/H₂O, 85° C. | 96% |
| 3 | Caprolactam/MeOH 25° C. | 91% |
| 4 | Caprolactam/MeOH, 50° C. | 90% |

The ¹H-NMR showed no peaks indicating the elastic fiber remained and overall ≥90% PA. Consequently, the elastic-fiber could be completely removed. A comparison of IR spectra of elastic fiber (1) and polymeric material (tights) before (2) and after (3) treatment is shown in FIG. 4.

Based on IR spectroscopy, it was shown that:
a) The elastic fiber was based polyurea and polyether(s), in detail was a polyether-polyurea copolymer.
b) IR description of material before treatment: The spectrum measured before treatment showed a mixture of polyamide 6.6 (PA 6.6) and an elastic fiber based on polyurea and polyether(s), in detail a polyether-polyurea copolymer (with its characteristic signals at 1730, 1708 and 1104 cm¹).
c) IR description of reobtained PA material: The IR spectrum measured of the reobtained material showed that it mainly consisted of PA 6.6. No additional peaks were found that belonged to the elastic fiber.

Therefrom, it was clearly visible that the elastic fiber (1) was completely removed after the treatment, and it was shown that the elastic fiber had been based on polyurea and polyether(s). In addition, some samples were analyzed focusing on their polymeric properties such as amino end groups (AEG), carboxyl end groups (CEG), relative viscosity (RV), extractables and molecular weight distribution (PDI=M_{w}/Mₙ via SEC) showing that end groups stayed unchanged, extractables were significantly decreased and subsequently molecular weight distribution narrows.

| | AEG | CEG | | Extract- | Mₙ | M_{w} | |
|---|---|---|---|---|---|---|---|
| | mmol/ | mmol/ | | ables | (SEC) | (SEC) | |
| Sample | kg | kg | RV | % | g/mol | g/mol | PDI |
| Reference | 7.60 | 73.30 | 2.273 | 3.08 | 26200 | 74200 | 2.8 |
| 1 | 7.30 | 73.20 | 2.405 | 0.56 | 24500 | 59000 | 2.4 |
| 2 | 8.20 | 66.40 | 2.276 | 1.91 | 26700 | 67500 | 2.4 |

### FIGURES

FIG. 1 shows a flow chart of the method described herein. In the beginning, a polymer blend PB1 and a solvent S1 are provided. The polymer blend PB1 comprises a polymer PM1, and a polymer PM2. The solvent S1 comprises a solvent SO1 and preferably a solvent SO2. The solvent SO1 and the solvent SO2 are not the same and the solubility of the polymer PM1 in the solvent S1 (g/L) is lower than the solubility of the polymer PM2 in the solvent S1 (g/L). Afterwards, the polymer blend PB1 is brought into contact with the solvent S1 to obtain a mixture MI1. Thereafter, the mixture MI1 is separated, preferably by a physical separation method, e.g. filtration, to obtain a polymer blend PB2 comprising the polymer PM1 and a solvent S2 comprising the polymer PM2. The polymer PM4 can be obtained either by adding water so the solvent S2 or by removing the solvent from the solvent S2. The obtained polymer blend PB2 and the polymer PM4 can be further processed and converted to a new polymer product PP1.

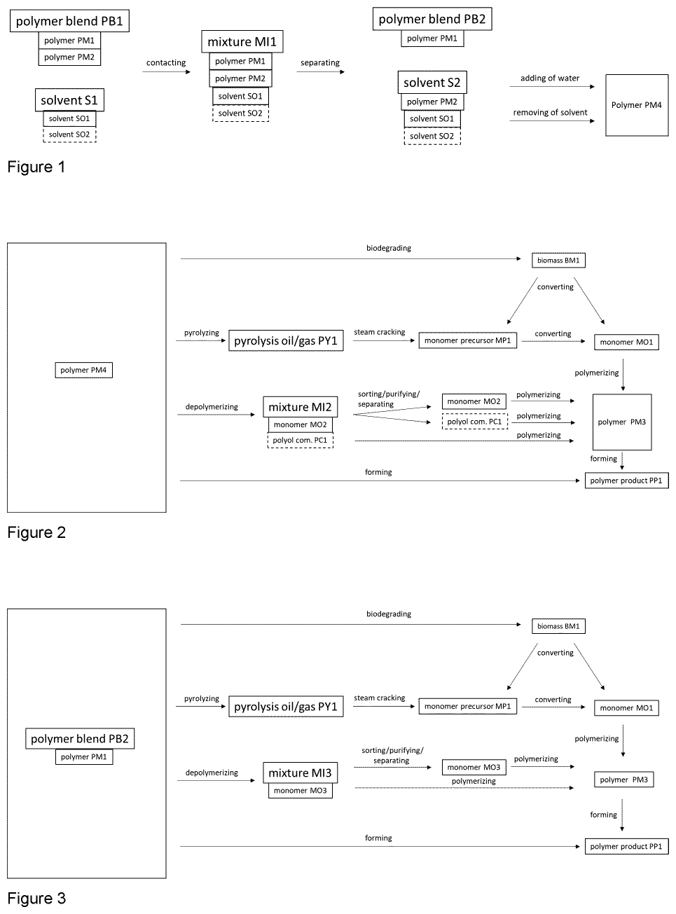

The further processing is depicted for the polymer PM4 in FIG. 2 and for the polymer blend PB2 in FIG. 3

FIGS. 2 and 3 show a flow chart of the further processing according to the method described herein. The polymer PM4 and/or the polymer blend PB2 and/or the solvent S2 (not shown) is/are biodegraded to obtain a biomass BM1. The obtained biomass BM1 can either be converted in a monomer precursor MP1 and then to a monomer MO2 or directly converted to the monomer MO1.

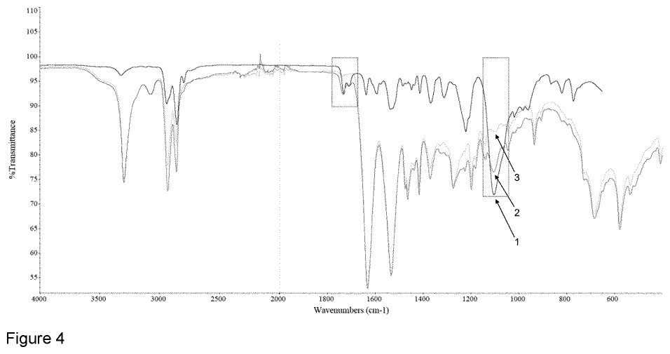

In another further processing, the polymer PM4 and/or the polymer blend PB2 and/or the solvent S2 (not shown) is/are pyrolyzed to obtain pyrolysis oil and/or pyrolysis gas PY1. Thereafter, the pyrolysis oil and/or pyrolysis gas PY1 is steam cracked to obtain a precursor MP1, which is then converted to obtain a monomer MO1.

The mixture MI2 and/or MI3 can either be directly polymerized or the monomer MO1 and/or MO2 can be polymerized to obtain the polymer PM3. Finally, the polymer PM3 can be formed to obtain polymer product PP1.

In another further processing, the polymer PM4 and/or the polymer blend PB2 is depolymerized to obtain a mixture MI2 comprising monomer MO2 and a mixture MI3 comprising monomer MO4, respectively. These monomers are sorted and/or purified and/or separated and then polymerized, preferably with (an) other monomer(s) and/or additive(s) to obtain polymer PM3, which then is formed to obtain the polymer product PP1.

Many modifications and other embodiments of the invention set forth herein will come to mind to the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1.-15. (canceled)

16. A method, comprising the following steps:
providing a polymer blend PB1 and a solvent S1,
wherein the polymer blend PB1 comprises:
i) a polymer PM1; and
ii) a polymer PM2;
wherein the solvent S1 comprises:
iii) a solvent SO1; and
wherein the solubility of the polymer PM1 in the solvent S1 (g/L) is lower than the solubility of the polymer PM2 in the solvent S1 (g/L); and
contacting the polymer blend PB1 with the solvent S1 to obtain a mixture MI1.

17. The method according to claim 16, wherein the solvent S1 comprises:
i) a solvent SO1; and
ii) a solvent SO2; and
wherein the solvent SO1 and the solvent SO2 are not the same.

18. The method according to claim 16, wherein the solvent SO1 is an amide.

19. The method according to claim 17, wherein the solvent SO2 comprises an —OH group.

20. The method according to claim 16, wherein at least one of:
the solvent S1 and the solvent S2 does not comprise dimethylformamide DMF, dimethylacetamide DMAc, 1-methylpyrrolidin-2-one NMP, 2-pyrrolidone, 2-piperidone, 2,2′-diaminodiethylamine (DETA), diisopropylamine, pyridine, pentylamine, N,N-diethylethanamine, diethylengylcol, tetrahydrofuran THF, hexamethylphosphoramide HMPA, acetonitrile, dimethylsulfoxide DMSO, and 1,4-butanediol; and
the polymer PM2 comprises at least one of polyurethane and polyurea.

21. The method according to claim 17, wherein the boiling point of the solvent SO2 is 0° C. to 150° C.

22. The method according to claim 17, wherein the ratio [weight/weight] of the solvent SO1 to the solvent SO2 is 0.01 or more and 100 or less.

23. The method according to claim 17, wherein the melting point of the solvent SO1 is higher than the melting point of the solvent SO2.

24. The method according to claim 16, wherein, in the contacting step, at least one of:
i) the polymer blend PB1 and the solvent S1 are at least once stirred, sonicated, or a combination of stirred and sonicated for a time t1;
ii) the polymer blend PB1 and the solvent S1 are in contact for the time t1; and
iii) the polymer blend PB1 and the solvent S1 are at least once heated to a temperature T1 for the time t1;
wherein the time t1 is 0.1 seconds or more and 7 days or less; and
wherein the temperature T1 is 0° C. or more and less than Tm, measured by DSC, of the polymer PM1.

25. The method according to claim 16, wherein the method further comprises the step:
separating the mixture MI1 to obtain a polymer blend PB2 comprising the polymer PM1 and a solvent S2 comprising the polymer PM2.

26. The method according to claim 16, wherein the method further comprises the step:
converting at least one of the solvent S2 and the polymer blend PB2 to obtain a monomer.

27. The method according to claim 26, wherein the method further comprises one of the following step(s):
repeating the providing, contacting, and separating steps one or more times to obtain a polymer product PP2;
recycling the polymer product PP1 one or more times to obtain a polymer product PP3; and
recycling the polymer product PP1 one or more times to obtain a recycled material RM1 and converting or forming the recycled material RM1 to obtain a polymer product PP4 comprising the recycled material RM1,
wherein the content CO1 is 1 weight-% or more;
wherein the content CO1 is 100 weight-% or less; and
wherein the polymer product PP1 and at least one of the polymer product PP2, PP3, and PP4 are the same.

28. The method according to claim 16, wherein the method further comprises the step:
certifying at least one of the polymer PM1, PM2, PM3, and PM4; the polymer blend PB2; and the polymer product PP1, PP2, PP3, and PP4 as circular in accordance with the International Sustainability and Carbon Certification (ISCC) standard.

29. At least one of a polymer blend PB2, polymer PM3, and PM4; a polymer product PP1, PP2, PP3, and PP4; and a polyol composition PC1, obtained by or obtainable by the method according to claim 16.

30. The at least one of a polymer blend PB2, polymer PM3, and PM4; a polymer product PP1, PP2, PP3, and PP4; and a polyol composition PC1 according to claim 29, wherein the at least one of the polymer blend PB2, polymer PM3, and PM4; the polymer product PP1, PP2, PP3, and PP4; and the polyol composition PC1 is configured to be used in at least one of a production of a polymer, and a recycling process.
